(19) United States
(12) Patent Application Publication
(10) Pub. No.: US 2023/0078604 A1
(43) Pub. Date: Mar. 16, 2023

(54) DETECTOR FOR OBJECT RECOGNITION

(71) Applicant: TRINAMIX GMBH, Ludwigshafen am Rhein (DE)

(72) Inventors: Benjamin REIN, Ludwigshafen (DE); Patrick SCHINDLER, Ludwigshafen (DE); Friedrich SCHICK, Ludwigshafen (DE); Jakob UNGER, Ludwigshafen (DE); Peter SCHILLEN, Ludwigshafen (DE); Nils BERNER, Ludwigshafen (DE)

(21) Appl. No.: 17/795,890

(22) PCT Filed: Jan. 29, 2021
(86) PCT No.: PCT/EP2021/052075

§ 371 Date: Jul. 28, 2022

(30) Foreign Application Priority Data
Jan. 31, 2020 (EP) 20154961.5

(51) Int. Cl. G06T 7/70; G06T 7/521; G06T 7/60; G06V 10/141; G06V 10/60

(52) U.S. Cl. CPC G06T 7/70; G06T 7/521; G06T 7/60; G06V 10/141; G06V 10/60; G06V 2201/07; G06T 2207/10144; G06T 2207/20024

(57) ABSTRACT

A detector for object recognition includes an illumination source for projecting an illumination pattern on an area including at least one object; an optical sensor having a light-sensitive area and configured for determining a first image including a two-dimensional image of the area, and a second image including a plurality of reflection features generated in response to illumination, each reflection feature including a beam profile; an evaluation device for determining beam profile information for each reflection feature by analyzing their beam profiles, determining a three-dimensional image using the determined beam profile information, identifying the reflection features located inside and/or outside an image region, determining a depth level from the beam profile information of the reflection features located inside and/or outside of the image region, determining a material property of the object from the beam profile information, and determining a position and/or orientation of the object.

### CROSS-REFERENCE TO RELATED APPLICATIONS

This application is a U.S. National Phase Application of International Patent Application No. PCT/EP2021/052075, filed Jan. 29, 2021, which claims priority to European Patent Application No. 20154961.5, filed Jan. 31, 2020, each of which is hereby incorporated by reference herein.

### DESCRIPTION

### Field of the Invention

The invention relates to a detector and a method for object recognition and various uses of the detector. The devices, methods and uses according to the present invention specifically may be employed for example in various areas of daily life, security technology, gaming, traffic technology, production technology, photography such as digital photography or video photography for arts, documentation or technical purposes, safety technology, information technology, agriculture, crop protection, maintenance, cosmetics, medical technology or in the sciences. However, other applications are also possible.

### Prior Art

Automatic object recognition of metal object is challenging. Depending on angle metal object do not or only sparsely reflect light from an illumination source such that a reliable three dimensional image generation is not possible. In order to allow automatic object recognition of metal objects it is known to combine 3D and 2D image information even if the 3D measurement cannot provide utilizable data. The 2D image may comprise image information which cannot be recorded via a 3D measurement. However, for 3D image sensors such as 3D time-of-Flight (ToF)-cameras no 2D image information or only 2D image information with very limit resolution is available. Moreover, it is necessary to determine during image capturing whether a 2D or 3D image was recorded in order to ensure correct analysis by an image analysis software. This is not possible by using purely the software driver controller of the camera due to missing real time behavior. In known methods high resolution 2D image data is recorded in addition to the 3D data by using a further camera. But position and angle of view of the further camera needs to be calibration in addition to the 3D camera. This calibration adds further uncertainty due to external influences such as decalibration due to temperature changes or mechanical stress. Moreover, it is very complex to synchronize both camera systems in order to record 2D and 3D images.

Other techniques such as structured light in principle have the possibility to generate 2D image data with high resolution. But 2D imaging is not performed since the Laser needs to be shut down for recording of the 2D image and in case of using band pass filter in the infrared wavelength range additional illumination may be necessary for image recording.

US 2016/0238377 A1 describes a modeling arrangement for modeling the topography of a three dimensional surface. The arrangement includes a light source arranged to produce substantially monochromatic and coherent electromagnetic radiation; a camera arranged to photograph the surface to be modeled at wavelengths emitted by the light source as well as wavelengths detected by the human eye; and a grating provided in connection with the first light source. The light source and the grating provided in connection with the light source are arranged jointly to produce a diffraction pattern of a known geometry on the surface to be modeled. Chen Guo-Hua et al. “Transparent object detection and location based on RGB-D cam-era”, JOURNAL OF PHYSICS: CONFERENCE SERIES, vol. 1183, 1 March 2019, page 012011, XP055707266, GB ISSN: 1742-6588, DOI: 10.1088/1742-6596/1183/1/012011 describes a method for transparent object detection and location that utilize depth image, RGB image and IR image. In detection process, an active depth sensor (Re-alSense) is firstly employed to retrieve the transparent candidates from the depth image and the corresponding candidates in the RGB image and IR image are then extracted separately. A transparent candidate classification algorithm is subsequently presented that uses SIFT features to recognize the transparent ones from the candidates. In location process, a group of RGB images and IR images was obtained by adjusting camera orientation to make its optical axis perpendicular to the normal direction of the plane on which the object is placed. The object contours in RGB image and IR image are then extracted, respectively. The three-dimensional object is finally reconstructed by means of stereo matching of the two contours, and the current pose information of the object is calculated in the end.

### PROBLEM ADDRESSED BY THE INVENTION

It is therefore an object of the present invention to provide devices and methods facing the above-mentioned technical challenges of known devices and methods. Specifically, it is an object of the present invention to provide devices and methods which allow reliable object recognition with a low technical effort and with low requirements in terms of technical resources and cost.

### SUMMARY OF THE INVENTION

This problem is solved by the invention with the features of the independent patent claims. Advantageous developments of the invention, which can be realized individually or in combination, are presented in the dependent claims and/or in the following specification and detailed embodiments.

As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “ one or more” will not be repeated, non-withstanding the fact that the respective feature or element may be present once or more than once.

Further, as used in the following, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such a way with other optional or non-optional features of the invention.

In a first aspect of the present invention a detector for object recognition is disclosed.

As used herein, the term “detector” may generally refer to an arbitrary sensor device configured for determining and/or detecting and/or sensing the at least one object. The detector may be a stationary device or a mobile device. Further, the detector may be a stand-alone device or may form part of another device, such as a computer, a vehicle or any other device. Further, the detector may be a hand-held device. Other embodiments of the detector are feasible.

As used herein, the term “object” may generally refer to an arbitrary physical body whose orientation and/or position is to be determined. The object may be at least one article. For example, the object may be at least one object selected from the group consisting of: a box, a bottle, a plate, a sheet of paper, a bag, a screw, a washer, a machined metal piece, a rubber seal, plastic pieces, wrapping, packing material. As used herein, the term “object recognition” may generally refer to identifying the object and determining at least one information about the position and/or orientation of the object. As used herein, the term “position” may refer to at least one item of information regarding a location of the object and/or at least one part of the object in space. Thus, the at least one item of information may imply at least one distance between at least one point of the object and the at least one detector. The distance may be a longitudinal coordinate or may contribute to determining a longitudinal coordinate of the point of the object. Additionally or alternatively, one or more other items of information regarding the location of the object and/or at least one part of the object may be determined. As an example, additionally, at least one transversal coordinate of the object and/or at least one part of the object may be determined. Thus, the position of the object may imply at least one longitudinal coordinate of the object and/or at least one part of the object. Additionally or alternatively, the position of the object may imply at least one transversal coordinate of the object and/or at least one part of the object. As used herein, the term “orientation” refers to angular position of the object in space. The orientation may be given by three spatial angles.

The detector comprises:

at least one illumination source configured for projecting at least one illumination pattern comprising a plurality of illumination features on at least one area comprising at least one object;

an optical sensor having at least one light sensitive area, wherein the optical sensor is configured for determining at least one first image comprising at least one two dimensional image of the area, wherein the optical sensor is configured for determining at least one second image comprising a plurality of reflection features generated by the area in response to illumination by the illumination features;

at least one evaluation device, wherein the evaluation device is configured for evaluating the first image and the second image, wherein each of the reflections features comprises at least one beam profile, wherein the evaluation device is configured for determining beam profile information for each of the reflection features by analysis of their beam profiles, wherein the evaluation device is configured for determining at least one three-dimensional image using the determined beam profile information, wherein the evaluation of the first image comprises identifying at least one pre-defined or pre-determined geometrical feature, wherein the evaluation device is configured for identifying the reflection features which are located inside an image region the geometrical feature and/or for identifying the reflection features which are located outside the image region of the geometrical feature,

wherein the evaluation device is configured for determining at least one depth level from the beam profile information of the reflection features located inside and/or outside of the image region of the geometrical feature,

wherein the evaluation device is configured for determining at least one material property of the object from the beam profile information of the reflection features located inside and/or outside of the image region of the geometrical feature, wherein the evaluation device is configured for determining at least one position and/or orientation of the object by considering the depth level and/or the material property and pre-determined or predefined information about shape and/or size of the object.

The object may be located within a scene and/or may have a surrounding environment. Specifically, the object may be located in at least one area. As used herein, the term “area” in this context may generally refer to at least one surface and/or region. As used herein, the term “area comprising the object” may generally refer to at least one surface on which the object is located and/or at least one region in which the object is located. The area may comprise additional elements such as the surrounding environment.

The illumination source is configured for projecting at least one illumination pattern comprising a plurality of illumination features on at least one area comprising at least one object. As used herein, the term “illumination source” may generally refers to at least one arbitrary device adapted to provide the at least one illumination light beam for illumination of the object. The illumination source may be adapted to directly or indirectly illuminating the object, wherein the illumination pattern is reflected or scattered by the object and, thereby, is at least partially directed towards the detector. The illumination source may be adapted to illuminate the object, for example, by directing a light beam towards the object, which reflects the light beam. The illumination source may be configured for generating an illuminating light beam for illuminating the object.

The illumination source may comprise at least one light source. The illumination source may comprise a plurality of light sources. The illumination source may comprise an artificial illumination source, in particular at least one laser source and/or at least one incandescent lamp and/or at least one semiconductor light source, for example, at least one light-emitting diode, in particular an organic and/or inorganic light-emitting diode. As an example, the light emitted by the illumination source may have a wavelength of 300 to 1100nm, especially 500 to 1100 nm. Additionally or alternatively, light in the infrared spectral range may be used, such as in the range of 780 nm to 3.0 μm. Specifically, the light in the part of the near infrared region where silicon photodiodes are applicable specifically in the range of 700 nm to 1100 nm may be used. The illumination source may be configured for generating the at least one illumination pattern in the infrared region. Using light in the near infrared region allows that light is not or only weakly detected by human eyes and is still detectable by silicon sensors, in particular standard silicon sensors.

As used herein, the term “ray” generally refers to a line that is perpendicular to wavefronts of light which points in a direction of energy flow. As used herein, the term “beam” generally refers to a collection of rays. In the following, the terms “ray” and “beam” will be used as synonyms. As further used herein, the term “light beam” generally refers to an amount of light, specifically an amount of light traveling essentially in the same direction, including the possibility of the light beam having a spreading angle or widening angle. The light beam may have a spatial extension. Specifically, the light beam may have a non-Gaussian beam profile. The beam profile may be selected from the group consisting of a trapezoid beam profile; a triangle beam profile; a conical beam profile. The trapezoid beam profile may have a plateau region and at least one edge region. The light beam specifically may be a Gaussian light beam or a linear combination of Gaussian light beams, as will be outlined in further detail below. Other embodiments are feasible, however. The transfer device may be configured for one or more of adjusting, defining and determining the beam profile, in particular a shape of the beam profile.

The illumination source may be configured for emitting light at a single wavelength. Specifically, the wavelength may be in the near infrared region. Using near infrared light may be advantageous since in the near infrared region human skin exhibits a unique reflection beam profile and significant absorption and diffusion, as will be outlined below. In other embodiments, the illumination may be adapted to emit light with a plurality of wavelengths allowing additional measurements in other wavelengths channels

The illumination source may be or may comprise at least one multiple beam light source. For example, the illumination source may comprise at least one laser source and one or more diffractive optical elements (DOEs). Specifically, the illumination source may comprise at least one laser and/or laser source. Various types of lasers may be employed, such as semiconductor lasers, double heterostructure lasers, external cavity lasers, separate confinement heterostructure lasers, quantum cascade lasers, distributed bragg reflector lasers, polariton lasers, hybrid silicon lasers, extended cavity diode lasers, quantum dot lasers, volume Bragg grating lasers, Indium Arsenide lasers, transistor lasers, diode pumped lasers, distributed feedback lasers, quantum well lasers, interband cascade lasers, Gallium Arsenide lasers, semiconductor ring laser, extended cavity diode lasers, or vertical cavity surface-emitting lasers. Additionally or alternatively, non-laser light sources may be used, such as LEDs and/or light bulbs. The illumination source may comprise one or more diffractive optical elements (DOEs) adapted to generate the illumination pattern. For example, the illumination source may be adapted to generate and/or to project a cloud of points, for example the illumination source may comprise one or more of at least one digital light processing projector, at least one LCoS projector, at least one spatial light modulator; at least one diffractive optical element; at least one array of light emitting diodes; at least one array of laser light sources. On account of their generally defined beam profiles and other properties of handleability, the use of at least one laser source as the illumination source is particularly preferred. The illumination source may be integrated into a housing of the detector.

The illumination source may be one of attached to or integrated into a mobile device such as a smartphone. The illumination source may be used for further functions that may be used in determining an image such as for an autofocus function. The illumination device may be integrated in a mobile device or attached to a mobile device such as by using a connector such as a USB- or phone-connector such as the headphone jack.

Further, the illumination source may be configured for emitting modulated or non-modulated light. In case a plurality of illumination sources is used, the different illumination sources may have different modulation frequencies which, as outlined in further detail below, later on may be used for distinguishing the light beams.

The light beam or light beams generated by the illumination source generally may propagate parallel to the optical axis or tilted with respect to the optical axis, e.g. including an angle with the optical axis. The detector may be configured such that the light beam or light beams propagates from the detector towards the object along an optical axis of the detector. For this purpose, the detector may comprise at least one reflective element, preferably at least one prism, for deflecting the illuminating light beam onto the optical axis. As an example, the light beam or light beams, such as the laser light beam, and the optical axis may include an angle of less than 10°, preferably less than 5° or even less than 2°. Other embodiments, however, are feasible. Further, the light beam or light beams may be on the optical axis or off the optical axis. As an example, the light beam or light beams may be parallel to the optical axis having a distance of less than 10 mm to the optical axis, preferably less than 5 mm to the optical axis or even less than 1 mm to the optical axis or may even coincide with the optical axis.

As used herein, the term “at least one illumination pattern” refers to at least one arbitrary pattern comprising at least one illumination feature adapted to illuminate at least one part of the object. As used herein, the term “illumination feature” refers to at least one at least partially extended feature of the pattern. The illumination pattern may comprise a single illumination feature. The illumination pattern may comprise a plurality of illumination features. The illumination pattern may be selected from the group consisting of: at least one point pattern; at least one line pattern; at least one stripe pattern; at least one checkerboard pattern; at least one pattern comprising an arrangement of periodic or non periodic features. The illumination pattern may comprise regular and/or constant and/or periodic pattern such as a triangular pattern, a rectangular pattern, a hexagonal pattern or a pattern comprising further convex tilings. The illumination pattern may exhibit the at least one illumination feature selected from the group consisting of: at least one point; at least one line; at least two lines such as parallel or crossing lines; at least one point and one line; at least one arrangement of periodic or non-periodic feature; at least one arbitrary shaped featured. The illumination pattern may comprise at least one pattern selected from the group consisting of: at least one point pattern, in particular a pseudo-random point pattern; a random point pattern or a quasi random pattern; at least one Sobol pattern; at least one quasiperiodic pattern; at least one pattern comprising at least one pre-known feature at least one regular pattern; at least one triangular pattern; at least one hexagonal pattern; at least one rectangular pattern at least one pattern comprising convex uniform tilings; at least one line pattern comprising at least one line; at least one line pattern comprising at least two lines such as parallel or crossing lines. For example, the illumination source may be adapted to generate and/or to project a cloud of points. The illumination source may comprise the at least one light projector adapted to generate a cloud of points such that the illumination pattern may comprise a plurality of point pattern. The illumination source may comprise at least one mask adapted to generate the illumination pattern from at least one light beam generated by the illumination source.

A distance between two features of the illumination pattern and/or an area of the at least one illumination feature may depend on the circle of confusion in the image. As outlined above, the illumination source may comprise the at least one light source configured for generating the at least one illumination pattern. Specifically, the illumination source comprises at least one laser source and/or at least one laser diode which is designated for generating laser radiation. The illumination source may comprise the at least one diffractive optical element (DOE). The detector may comprise at least one point projector, such as the at least one laser source and the DOE, adapted to project at least one point pattern.

As further used herein, the term “projecting at least one illumination pattern” refers to providing the at least one illumination pattern for illuminating the at least one object.

For example, the projected illumination pattern may be a periodic point pattern. The projected illumination pattern may have a low point density. For example, the illumination pattern may comprise at least one periodic point pattern having a low point density, wherein the illumina pattern has ≤2500 points per field of view. In comparison with structured light having typically a point density of 10 k-30 k in a field of view of 55×38° the illumination pattern according to the present invention may be less dense. This may allow more power per point such that the proposed technique is less dependent on ambient light compared to structured light.

The detector may comprise at least one further illumination source. The further illumination source may comprise one or more of at least one further light source such as at least one light emitting diode (LED) or at least one vertical-cavity surface-emitting laser (VCSEL) array. The further illumination source may comprise at least one optical element such as at least one diffusor or at least one lens. The further illumination source may be configured for providing additional illumination for imaging of the first image. For example, the further illumination source may be used in situations in which it is not possible or difficult for recording the reflection pattern, e.g. in case of highly reflective metallic surfaces, in order to ensure a good illumination and, thus, contrasts for two-dimensional images such that a two-dimensional image recognition is possible.

The detector may comprise a single camera comprising the optical sensor. The detector may comprise a plurality of cameras each comprising an optical sensor or a plurality of optical sensors.

The optical sensor has at least one light sensitive area. As used herein, an “optical sensor” generally refers to a light-sensitive device for detecting a light beam, such as for detecting an illumination and/or a light spot generated by at least one light beam. As further used herein, a “light-sensitive area” generally refers to an area of the optical sensor which may be illuminated externally, by the at least one light beam, in response to which illumination at least one sensor signal is generated. The light-sensitive area may specifically be located on a surface of the respective optical sensor. Other embodiments, however, are feasible. The detector may comprise a plurality of optical sensors each having a light sensitive area. As used herein, the term “the optical sensors each having at least one light sensitive area” refers to configurations with a plurality of single optical sensors each having one light sensitive area and to configurations with one combined optical sensor having a plurality of light sensitive areas. The term “optical sensor” furthermore refers to a light-sensitive device configured to generate one output signal. In case the detector comprises a plurality of optical sensors, each optical sensor may be embodied such that precisely one light-sensitive area is present in the respective optical sensor, such as by providing precisely one light-sensitive area which may be illuminated, in response to which illumination precisely one uniform sensor signal is created for the whole optical sensor. Thus, each optical sensor may be a single area optical sensor. The use of the single area optical sensors, however, renders the setup of the detector specifically simple and efficient. Thus, as an example, commercially available photo-sensors, such as commercially available silicon photodiodes, each having precisely one sensitive area, may be used in the set-up. Other embodiments, however, are feasible.

Preferably, the light sensitive area may be oriented essentially perpendicular to an optical axis of the detector. The optical axis may be a straight optical axis or may be bent or even split, such as by using one or more deflection elements and/or by using one or more beam splitters, wherein the essentially perpendicular orientation, in the latter cases, may refer to the local optical axis in the respective branch or beam path of the optical setup.

The optical sensor specifically may be or may comprise at least one photodetector, preferably inorganic photodetectors, more preferably inorganic semiconductor photodetectors, most preferably silicon photodetectors. Specifically, the optical sensor may be sensitive in the infrared spectral range. AH pixels of the matrix or at least a group of the optical sensors of the matrix specifically may be identical. Groups of identical pixels of the matrix specifically may be provided for different spectral ranges, or all pixels may be identical in terms of spectral sensitivity.

Further, the pixels may be identical in size and/or with regard to their electronic or optoelectronic properties. Specifically, the optical sensor may be or may comprise at least one inorganic photodiode which are sensitive in the infrared spectral range, preferably in the range of 700 nm to 3.0 micrometers. Specifically, the optical sensor may be sensitive in the part of the near infrared region where silicon photodiodes are applicable specifically in the range of 700 nm to 1100 nm. Infrared optical sensors which may be used for optical sensors may be commercially available infrared optical sensors, such as infrared optical sensors commercially available under the brand name Hertzstueck™ from trinamiX™ GmbH, D-67056 Ludwigshafen am Rhein, Germany. Thus, as an example, the optical sensor may comprise at least one optical sensor of an intrinsic photovoltaic type, more preferably at least one semiconductor photodiode selected from the group consisting of: a Ge photodiode, an InGaAs photodiode, an extended InGaAs photodiode, an InAs photodiode, an InSb photodiode, a HgCdTe photodiode. Additionally or alternatively, the optical sensor may comprise at least one optical sensor of an extrinsic photovoltaic type, more preferably at least one semiconductor photodiode selected from the group consisting of: a Ge:Au photodiode, a Ge:Hg photodiode, a Ge:Cu photodiode, a Ge:Zn photodiode, a Si:Ga photodiode, a Si:As photodiode. Additionally or alternatively, the optical sensor may comprise at least one photoconductive sensor such as a PbS or PbSe sensor, a bolometer, preferably a bolometer selected from the group consisting of a VO bolometer and an amorphous Si bolometer.

The optical sensor may be sensitive in one or more of the ultraviolet, the visible or the infrared spectral range. Specifically, the optical sensor may be sensitive in the visible spectral range from 500 nm to 780 nm, most preferably at 650 nm to 750 nm or at 690 nm to 700 nm. Specifically, the optical sensor may be sensitive in the near infrared region. Specifically, the optical sensor may be sensitive in the part of the near infrared region where silicon photodiodes are applicable specifically in the range of 700 nm to 1000 nm. The optical sensor, specifically, may be sensitive in the infrared spectral range, specifically in the range of 780 nm to 3.0 micrometers. For example, the optical sensor each, independently, may be or may comprise at least one element selected from the group consisting of a photodiode, a photocell, a photoconductor, a phototransistor or any combination thereof. For example, the optical sensor may be or may comprise at least one element selected from the group consisting of a CCD sensor element, a CMOS sensor element, a photodiode, a photocell, a photoconductor, a phototransistor or any combination thereof. Any other type of photosensitive element may be used. The photosensitive element generally may fully or partially be made of inorganic materials and/or may fully or partially be made of organic materials. Most commonly, one or more photodiodes may be used, such as commercially available photodiodes, e.g. inorganic semiconductor photodiodes.

The optical sensor may comprise at least one sensor element comprising a matrix of pixels. Thus, as an example, the optical sensor may be part of or constitute a pixelated optical device. For example, the optical sensor may be and/or may comprise at least one CCD and/or CMOS device. As an example, the optical sensor may be part of or constitute at least one CCD and/or CMOS device having a matrix of pixels, each pixel forming a light-sensitive area.

As used herein, the term “sensor element” generally refers to a device or a combination of a plurality of devices configured for sensing at least one parameter. In the present case, the parameter specifically may be an optical parameter, and the sensor element specifically may be an optical sensor element. The sensor element may be formed as a unitary, single device or as a combination of several devices. The sensor element comprises a matrix of optical sensors. The sensor element may comprise at least one CMOS sensor. The matrix may be composed of independent pixels such as of independent optical sensors. Thus, a matrix of inorganic photodiodes may be composed. Alternatively, however, a commercially available matrix may be used, such as one or more of a CCD detector, such as a CCD detector chip, and/or a CMOS detector, such as a CMOS detector chip. Thus, generally, the sensor element may be and/or may comprise at least one CCD and/or CMOS device and/or the optical sensors may form a sensor array or may be part of a sensor array, such as the above-mentioned matrix. Thus, as an example, the sensor element may comprise an array of pixels, such as a rectangular array, having m rows and n columns, with m, n, independently, being positive integers. Preferably, more than one column and more than one row is given, i.e. n>1, m>1. Thus, as an example, n may be 2 to 16 or higher and m may be 2 to 16 or higher. Preferably, the ratio of the number of rows and the number of columns is close to 1. As an example, n and m may be selected such that 0.3≤m/n ≤3, such as by choosing m/n=1:1, 4:3, 16:9 or similar. As an example, the array may be a square array, having an equal number of rows and columns, such as by choosing m=2, n=2 or m=3, n=3 or the like.

The matrix may be composed of independent pixels such as of independent optical sensors. Thus, a matrix of inorganic photodiodes may be composed. Alternatively, however, a commercially available matrix may be used, such as one or more of a CCD detector, such as a CCD detector chip, and/or a CMOS detector, such as a CMOS detector chip. Thus, generally, the optical sensor may be and/or may comprise at least one CCD and/or CMOS device and/or the optical sensors of the detector may form a sensor array or may be part of a sensor array, such as the above-mentioned matrix.

The matrix specifically may be a rectangular matrix having at least one row, preferably a plurality of rows, and a plurality of columns. As an example, the rows and columns may be oriented essentially perpendicular. As used herein, the term “essentially perpendicular” refers to the condition of a perpendicular orientation, with a tolerance of e.g. ±20° or less, preferably a tolerance of ±10° or less, more preferably a tolerance of ±5° or less. Similarly, the term “essentially parallel” refers to the condition of a parallel orientation, with a tolerance of e.g. ±20° or less, preferably a tolerance of ±10° or less, more preferably a tolerance of ±5° or less. Thus, as an example, tolerances of less than 20°, specifically less than 10° or even less than 5°, may be acceptable. In order to provide a wide range of view, the matrix specifically may have at least 10 rows, preferably at least 500 rows, more preferably at least 1000 rows. Similarly, the matrix may have at least 10 columns, preferably at least 500 columns, more preferably at least 1000 columns. The matrix may comprise at least 50 optical sensors, preferably at least 100000 optical sensors, more preferably at least 5000000 optical sensors. The matrix may comprise a number of pixels in a multi-mega pixel range. Other embodiments, however, are feasible. Thus, in setups in which an axial rotational symmetry is to be expected, circular arrangements or concentric arrangements of the optical sensors of the matrix, which may also be referred to as pixels, may be preferred.

Thus, as an example, the sensor element may be part of or constitute a pixelated optical device. For example, the sensor element may be and/or may comprise at least one CCD and/or CMOS device. As an example, the sensor element may be part of or constitute at least one CCD and/or CMOS device having a matrix of pixels, each pixel forming a light-sensitive area. The sensor element may employ a rolling shutter or global shutter method to read out the matrix of optical sensors.

The optical sensor is configured for determining at least one first image comprising at least one two dimensional image of the area.

As used herein, without limitation, the term “image” specifically may relate to data recorded by using the optical sensor, such as a plurality of electronic readings from an imaging device, such as the pixels of the sensor element. The image itself, thus, may comprise pixels, the pixels of the image correlating to pixels of the matrix of the sensor element. Consequently, when referring to “pixels”, reference is either made to the units of image information generated by the single pixels of the sensor element or to the single pixels of the sensor element directly.

As used herein, the term “two dimensional image” may generally refer to an image having information about transversal coordinates such as the dimensions of height and width only. As used herein, the term “three dimensional image” may generally refer to an image having information about transversal coordinates and additionally about the longitudinal coordinate such as the dimensions of height, width and depth.

The optical sensor is configured for determining at least one second image comprising a plurality of reflection features generated by the area in response to illumination by the illumination features. As used herein, the term “reflection feature” may refer to a feature in an image plane generated by the object in response to illumination, specifically with at least one illumination feature.

The first image and the second image may be determined, in particular recorded, at different time points. Recording of the first image and the second time limit may be performed with a temporal shift. Specifically, a single camera comprising the optical sensor may record with a temporal shift a two-dimensional image and an image of a projected pattern. Recording the first and the second image at different time points may ensure that the evaluation device can distinguish between the first and the second image and can apply the appropriate evaluation routine. Moreover, it is possible to adapt the illumination situation for the first image if necessary and in particular independent from the illumination for the second image. The detector may comprise at least one control unit. As used herein, the term “control unit” may refer to an arbitrary device configured for controlling operation of one or more components or elements of the detector. The control unit may be designed as hardware component of the detector. In particular, the control unit may comprise at least one microcontroller. The control unit may be configured for controlling the optical sensor and/or the illumination source. The control unit may be configured for triggering projecting of the illumination pattern and/or imaging of the second image. Specifically, the control unit may be configured for controlling the optical sensor, in particular frame rate and/or illumination time, via trigger signals. The control unit may be configured for adapting and/or adjusting the illumination time from frame to frame. As used herein, the term “frame” may refer to a time range for determining one image. This may allow adapting and/or adjusting illumination time for the first image, e.g. in order to have contrasts at the edges, and at the same time adapting and/or adjusting illumination time for the second image to maintain contrast of the reflection features. Additionally, the control unit may, at the same time and independently, control the elements of the illumination source and/or the further illumination source.

Specifically, the control unit may be configured for adapting exposure time for projection of the illumination pattern. The second image may be recorded with different illumination times. Dark regions of the area may require more light in comparison to lighter regions, which may result to run into saturation for the lighter regions. Therefore, the detector may be configured for recording a plurality of images of the reflection pattern, wherein the images may be recorded with different illumination times. The detector may be configured for generating and/or composing the second image from said images. The evaluation device may be configured for performing at least one algorithm on said images which were recorded with different illumination times.

As outlined above, the detector may comprise the further illumination source configured for illuminating the area for determining the first image. The control unit may be configured for controlling the further illumination source. The control unit may be configured for triggering illumination of the area by light generated by the further illumination source and imaging of the first image. The control unit may be configured for adapting exposure time for projection of the illumination pattern and illumination by light generated by the further illumination source.

The detector may comprise at least one first filter element. As used herein, the term “filter element” may refer to at least one arbitrary optical element configured for selectively blocking and transmitting light depending on wavelength. The first filter element may be configured for transmitting light in the infrared spectral range and for at least partially blocking light of other spectral ranges. The first filter element may be a monochromatic bandpass filter configured for transmitting light in a small spectral range. For example, the spectral range or bandwidth may be ±100 nm, preferably ±50 nm, most preferably ±35 nm or even less. For example, the first filter element may be configured for transmitting light having a central wavelength of 808 nm, 830 nm, 850 nm, 905 nm or 940 nm. For example, the first filter element may be configured for transmitting light having a central wavelength of 850 nm with a bandwidth of 70 nm or less. The first filter element may have a minimal angle dependency such that the spectral range can be small. This may result in a low dependency on ambient light, wherein at the same time an enhanced vignetting effect can be prevented. For example, the detector may comprise the single camera having the optical sensor and, in addition, the first filter element. The first filter element may ensure that even in presence of ambient light recording of the reflection pattern is possible and at the same time to maintain laser output power low such that eye safety operation in laser class 1 is ensured.

Additionally or alternatively to the first filter element, the detector may comprise at least one polarization filter. The polarization filter may be positioned 90° rotated with respect to the polarization of the illumination source such as of the laser. This may allow weaken direct back-reflections from e.g. metallic materials, and/or may allow detection of points from the projected pattern which can be evaluated using the depth-from-photon-ratio technique even if it is directly reflected and not diffusely scattered. The illumination source for determining the two-dimensional image may be non-polarized such that the 2D imaging may not be influenced by the polarization filter, or only by that brightness is reduced.

Additionally or alternatively, the detector may comprise at least one second filter element. The second filter element may be a band-pass filter. The second filter element may be configured for transmitting light in the visual spectral range and for at least partially blocking light of other spectral ranges.

The spectrum of the illumination source and/or of the further illumination source may be selected depending on the used filter elements. For example, in case of the first filter element having a central wavelength of 850 nm, the illumination source may comprise at least one light source generating a wavelength of 850 nm such as at least one infrared (IR)-LED.

The evaluation device is configured for evaluating the first image and the second image. As further used herein, the term “evaluation device” generally refers to an arbitrary device adapted to perform the named operations, preferably by using at least one data processing device and, more preferably, by using at least one processor and/or at least one application-specific integrated circuit. Thus, as an example, the at least one evaluation device may comprise at least one data processing device having a software code stored thereon comprising a number of computer commands. The evaluation device may provide one or more hardware elements for performing one or more of the named operations and/or may provide one or more processors with software running thereon for performing one or more of the named operations. Operations, including evaluating the images. Specifically the determining the reflection beam profile and indication of the surface, may be performed by the at least one evaluation device. Thus, as an example, one or more of the above-mentioned instructions may be implemented in software and/or hardware. Thus, as an example, the evaluation device may comprise one or more programmable devices such as one or more computers, application-specific integrated circuits (ASICs), Digital Signal Processors (DSPs), or Field Programmable Gate Arrays (FPGAs) which are configured to perform the above-mentioned evaluation. Additionally or alternatively, however, the evaluation device may also fully or partially be embodied by hardware.

The evaluation device and the detector may fully or partially be integrated into a single device. Thus, generally, the evaluation device also may form part of the detector. Alternatively, the evaluation device and the detector may fully or partially be embodied as separate devices. The detector may comprise further components.

The evaluation device may be or may comprise one or more integrated circuits, such as one or more application-specific integrated circuits (ASICs), and/or one or more data processing devices, such as one or more computers, preferably one or more microcomputers and/or microcontrollers, Field Programmable Arrays, or Digital Signal Processors. Additional components may be comprised, such as one or more preprocessing devices and/or data acquisition devices, such as one or more devices for receiving and/or preprocessing of the sensor signals, such as one or more AD-converters and/or one or more filters. Further, the evaluation device may comprise one or more measurement devices, such as one or more measurement devices for measuring electrical currents and/or electrical voltages. Further, the evaluation device may comprise one or more data storage devices. Further, the evaluation device may comprise one or more interfaces, such as one or more wireless interfaces and/or one or more wire-bound interfaces.

The evaluation device can be connected to or may comprise at least one further data processing device that may be used for one or more of displaying, visualizing, analyzing, distributing, communicating or further processing of information, such as information obtained by the optical sensor and/or by the evaluation device. The data processing device, as an example, may be connected or incorporate at least one of a display, a projector, a monitor, an LCD, a TFT, a loudspeaker, a multichannel sound system, an LED pattern, or a further visualization device. It may further be connected or incorporate at least one of a communication device or communication interface, a connector or a port, capable of sending encrypted or unencrypted information using one or more of email, text messages, telephone, Bluetooth, Wi-Fi, infrared or internet interfaces, ports or connections. It may further be connected to or incorporate at least one of a processor, a graphics processor, a CPU, an Open Multimedia Applications Platform (OMAP™), an integrated circuit, a system on a chip such as products from the Apple A series or the Samsung S3C2 series, a microcontroller or microprocessor, one or more memory blocks such as ROM, RAM, EEPROM, or flash memory, timing sources such as oscillators or phase-locked loops, counter-timers, real-time timers, or power-on reset generators, voltage regulators, power management circuits, or DMA controllers. Individual units may further be connected by buses such as AMBA buses or be integrated in an Internet of Things or Industry 4.0 type network.

The evaluation device and/or the data processing device may be connected by or have further external interfaces or ports such as one or more of serial or parallel interfaces or ports, USB, Centronics Port, FireWire, HDMI, Ethernet, Bluetooth, RFID, Wi-Fi, USART, or SPI, or analogue interfaces or ports such as one or more of ADCs or DACs, or standardized interfaces or ports to further devices such as a 2D-camera device using an RGB-interface such as CameraLink. The evaluation device and/or the data processing device may further be connected by one or more of interprocessor interfaces or ports, FPGA-FPGA-interfaces, or serial or parallel interfaces ports. The evaluation device and the data processing device may further be connected to one or more of an optical disc drive, a CD-RW drive, a DVD+RW drive, a flash drive, a memory card, a disk drive, a hard disk drive, a solid state disk or a solid state hard disk.

The evaluation device and/or the data processing device may be connected by or have one or more further external connectors such as one or more of phone connectors, RCA connectors, VGA connectors, hermaphrodite connectors, USB connectors, HDMI connectors, 8P8C connectors, BCN connectors, IEC 60320 C14 connectors, optical fiber connectors, D-subminiature connectors, RF connectors, coaxial connectors, SCART connectors, XLR connectors, and/or may incorporate at least one suitable socket for one or more of these connectors.

The evaluation of the first image comprises identifying at least one pre-defined or pre-determined geometrical feature. As used herein, the term “geometrical feature” refers to at least one characteristic element of the object. The geometrical feature may be at least one characteristic element of the object selected from the group consisting of: a shape, a relative position of at least one edge, at least one borehole, at least one reflection point, at least one line, at least one surface, at least one circle, at least one disk, the full object, a part of the object and the like. The evaluation device may comprise at least one data storage device. The data storage device may comprise at least one table and/or at least one lookup table of geometrical features and/or pre-determined or predefined information about shape and/or size of the object. Additionally or alternatively, the detector may comprise at least one user interface via which a user can enter the at least one geometrical feature.

The evaluation device may be configured for evaluating in a first step the second image. The evaluation of the second image may provide, as will be outlined in more detail below, 3D information of the reflection features. The evaluation device may be configured for estimating a location of the geometrical feature in the first image by considering the 3D information of the reflection features. This may reduce effort of search for geometrical feature in the first image significantly.

The evaluation device may be configured for identifying the geometrical feature by using at least one image processing process. The image processing process may comprise one or more of at least one template matching algorithm; at least one Hough-transformation; applying a Canny edge filter; applying a Sobel filter; applying a combination of filters. The evaluation device may be configured for performing at least one plausibility check. The plausibility check may comprise comparing the identified geometrical feature compared to at least one known geometrical feature of the object. For example, a user may enter a known geometrical feature via the user interface for the plausibility check.

The evaluation device is configured for evaluating of the second image. The evaluation of the second image may comprise generating a three-dimensional image.

Each of the reflections features comprises at least one beam profile. As used herein, the term “beam profile” of the reflection feature may generally refer to at least one intensity distribution of the reflection feature, such as of a light spot on the optical sensor, as a function of the pixel.

The beam profile may be selected from the group consisting of a trapezoid beam profile; a triangle beam profile; a conical beam profile and a linear combination of Gaussian beam profiles. The evaluation device is configured for determining beam profile information for each of the reflection features by analysis of their beam profiles.

The evaluation device may be configured for determining the beam profile of each of the reflection features. As used herein, the term “determining the beam profile” refers to identifying at least one reflection feature provided by the optical sensor and/or selecting at least one reflection feature provided by the optical sensor and evaluating at least one intensity distribution of the reflection feature. As an example, a region of the matrix may be used and evaluated for determining the intensity distribution, such as a three-dimensional intensity distribution or a two-dimensional intensity distribution, such as along an axis or line through the matrix. As an example, a center of illumination by the light beam may be determined, such as by determining the at least one pixel having the highest illumination, and a cross-sectional axis may be chosen through the center of illumination. The intensity distribution may an intensity distribution as a function of a coordinate along this cross-sectional axis through the center of illumination. Other evaluation algorithms are feasible.

The evaluation device may be configured for performing at least one image analysis and/or image processing in order to identify the reflection features. The image analysis and/or image processing may use at least one feature detection algorithm. The image analysis and/or image processing may comprise one or more of the following: a filtering; a selection of at least one region of interest; a formation of a difference image between an image created by the sensor signals and at least one offset; an inversion of sensor signals by inverting an image created by the sensor signals; a formation of a difference image between an image created by the sensor signals at different times; a background correction; a decomposition into color channels; a decomposition into hue; saturation; and brightness channels; a frequency decomposition; a singular value decomposition; applying a blob detector; applying a corner detector; applying a Determinant of Hessian filter; applying a principle curvature-based region detector; applying a maximally stable extremal regions detector; applying a generalized Hough-transformation; applying a ridge detector; applying an affine invariant feature detector; applying an affine-adapted interest point operator; applying a Harris affine region detector; applying a Hessian affine region detector; applying a scale-invariant feature transform; applying a scale-space extrema detector; applying a local feature detector; applying speeded up robust features algorithm; applying a gradient location and orientation histogram algorithm; applying a histogram of oriented gradients descriptor; applying a Deriche edge detector; applying a differential edge detector; applying a spatio-temporal interest point detector; applying a Moravec corner detector; applying a Canny edge detector; applying a Laplacian of Gaussian filter; applying a Difference of Gaussian filter; applying a Sobel operator; applying a Laplace operator; applying a Scharr operator; applying a Prewitt operator; applying a Roberts operator; applying a Kirsch operator; applying a high-pass filter; applying a low-pass filter; applying a Fourier transformation; applying a Radon-transformation; applying a Hough-transformation; applying a wave-let-transformation; a thresholding; creating a binary image. The region of interest may be determined manually by a user or may be determined automatically, such as by recognizing an object within the image generated by the optical sensor.

For example, the illumination source may be configured for generating and/or projecting a cloud of points such that a plurality of illuminated regions is generated on the optical sensor, for example the CMOS detector. Additionally, disturbances may be present on the optical sensor such as disturbances due to speckles and/or extraneous light and/or multiple reflections. The evaluation device may be adapted to determine at least one region of interest, for example one or more pixels illuminated by the light beam which are used for determination of the longitudinal coordinate of the object. For example, the evaluation device may be adapted to perform a filtering method, for example, a blob-analysis and/or an edge filter and/or object recognition method.

The evaluation device may be configured for performing at least one image correction. The image correction may comprise at least one background subtraction. The evaluation device may be adapted to remove influences from background light from the reflection beam profile, for example, by an imaging without further illumination.

As used herein, the term “analysis of the beam profile” may generally refer to evaluating of the beam profile and may comprise at least one mathematical operation and/or at least one comparison and/or at least symmetrizing and/or at least one filtering and/or at least one normalizing. For example, the analysis of the beam profile may comprise at least one of a histogram analysis step, a calculation of a difference measure, application of a neural network, application of a machine learning algorithm. The evaluation device may be configured for symmetrizing and/or for normalizing and/or for filtering the beam profile, in particular to remove noise or asymmetries from recording under larger angles, recording edges or the like. The evaluation device may filter the beam profile by removing high spatial frequencies such as by spatial frequency analysis and/or median filtering or the like. Summarization may be performed by center of intensity of the light spot and averaging all intensities at the same distance to the center.

The evaluation device may be configured for normalizing the beam profile to a maximum intensity, in particular to account for intensity differences due to the recorded distance. The evaluation device may be configured for removing influences from background light from the reflection beam profile, for example, by an imaging without illumination.

The reflection feature may cover or may extend over at least one pixel of the image. For example, the reflection feature may cover or may extend over plurality of pixels. The evaluation device may be configured for determining and/or for selecting all pixels connected to and/or belonging to the reflection feature, e.g. a light spot. The evaluation device may be configured for determining the center of intensity by

$${R}_{c o i} = \frac{1}{l \cdot Σ j \cdot {r}_{p i x e l}} ,$$

wherein R_{coi} is a position of center of intensity, rₚᵢₓₑₗ is the pixel position and l=ΣⱼIₜₒₜₐₗ with j being the number of pixels j connected to and/or belonging to the reflection feature and Iₜₒₜₐₗ being the total intensity.

The evaluation device is configured for determining the beam profile information for each of the reflection features by analysis of their beam profiles. As used herein, the term “beam profile information” may generally refer to information about an intensity distribution of a light spot on the light sensitive area of the optical sensor. The beam profile information may comprise information about the longitudinal coordinate of the surface point or region having reflected the illumination feature. Additionally, the beam profile information may comprise information about a material property of said surface point or region having reflected the illumination feature.

The beam profile information may be the longitudinal coordinate of the surface point or region having reflected the illumination feature. The evaluation device may be configured for determining the beam profile information for each of the reflection features by using depth-from-photon-ratio technique. With respect to depth-from-photon-ratio (DPR) technique reference is made to WO 2018/091649 A1, WO 2018/091638 A1 and WO 2018/091640 A1, the full content of which is included by reference.

The analysis of the beam profile of one of the reflection features may comprise determining at least one first area and at least one second area of the beam profile. The first area of the beam profile may be an area A1 and the second area of the beam profile may be an area A2. The evaluation device may be configured for integrating the first area and the second area. The evaluation device may be configured to derive a combined signal, in particular a quotient Q, by one or more of dividing the integrated first area and the integrated second area, dividing multiples of the integrated first area and the integrated second area, dividing linear combinations of the integrated first area and the integrated second area. The evaluation device may be configured for determining at least two areas of the beam profile and/or to segment the beam profile in at least two segments comprising different areas of the beam profile, wherein overlapping of the areas may be possible as long as the areas are not congruent. For example, the evaluation device may be configured for determining a plurality of areas such as two, three, four, five, or up to ten areas. The evaluation device may be configured for segmenting the light spot into at least two areas of the beam profile and/or to segment the beam profile in at least two segments comprising different areas of the beam profile. The evaluation device may be configured for determining for at least two of the areas an integral of the beam profile over the respective area. The evaluation device may be configured for comparing at least two of the determined integrals. Specifically, the evaluation device may be configured for determining at least one first area and at least one second area of the reflection beam profile. As used herein, the term “area of the beam profile” generally refers to an arbitrary region of the beam profile at the position of the optical sensor used for determining the quotient Q. The first area of the beam profile and the second area of the reflection beam profile may be one or both of adjacent or overlapping regions. The first area of the beam profile and the second area of the beam profile may be not congruent in area. For example, the evaluation device may be configured for dividing a sensor region of the CMOS sensor into at least two sub-regions, wherein the evaluation device may be configured for dividing the sensor region of the CMOS sensor into at least one left part and at least one right part and/or at least one upper part and at least one lower part and/or at least one inner and at least one outer part. Additionally or alternatively, the detector may comprise at least two optical sensors, wherein the light-sensitive areas of a first optical sensor and of a second optical sensor may be arranged such that the first optical sensor is adapted to determine the first area of the reflection beam profile of the reflection feature and that the second optical sensor is adapted to determine the second area of the reflection beam profile of the reflection feature. The evaluation device may be adapted to integrate the first area and the second area. The evaluation device may be configured for using at least one pre-determined relationship between the quotient Q and the longitudinal coordinate for determining the longitudinal coordinate. The predetermined relationship may be one or more of an empiric relationship, a semi-empiric relationship and an analytically derived relationship. The evaluation device may comprise at least one data storage device for storing the predetermined relationship, such as a lookup list or a lookup table.

The first area of the beam profile may comprise essentially edge information of the beam profile and the second area of the beam profile comprises essentially center information of the beam profile, and/or the first area of the beam profile may comprise essentially information about a left part of the beam profile and the second area of the beam profile comprises essentially information about a right part of the beam profile. The beam profile may have a center, i.e. a maximum value of the beam profile and/or a center point of a plateau of the beam profile and/or a geometrical center of the light spot, and falling edges extending from the center. The second region may comprise inner regions of the cross section and the first region may comprise outer regions of the cross section. As used herein, the term “essentially center information” generally refers to a low proportion of edge information, i.e. proportion of the intensity distribution corresponding to edges, compared to a proportion of the center information, i.e. proportion of the intensity distribution corresponding to the center. Preferably, the center information has a proportion of edge information of less than 10%, more preferably of less than 5%, most preferably the center information comprises no edge content. As used herein, the term “essentially edge information” generally refers to a low proportion of center information compared to a proportion of the edge information. The edge information may comprise information of the whole beam profile, in particular from center and edge regions. The edge information may have a proportion of center information of less than 10%, preferably of less than 5%, more preferably the edge information comprises no center content. At least one area of the beam profile may be determined and/or selected as second area of the beam profile if it is close or around the center and comprises essentially center information. At least one area of the beam profile may be determined and/or selected as first area of the beam profile if it comprises at least parts of the falling edges of the cross section. For example, the whole area of the cross section may be determined as first region.

Other selections of the first area A1 and second area A2 may be feasible. For example, the first area may comprise essentially outer regions of the beam profile and the second area may comprise essentially inner regions of the beam profile. For example, in case of a two-dimensional beam profile, the beam profile may be divided in a left part and a right part, wherein the first area may comprise essentially areas of the left part of the beam profile and the second area may comprise essentially areas of the right part of the beam profile.

The edge information may comprise information relating to a number of photons in the first area of the beam profile and the center information may comprise information relating to a number of photons in the second area of the beam profile. The evaluation device may be configured for determining an area integral of the beam profile. The evaluation device may be configured for determining the edge information by integrating and/or summing of the first area. The evaluation device may be configured for determining the center information by integrating and/or summing of the second area. For example, the beam profile may be a trapezoid beam profile and the evaluation device may be configured for determining an integral of the trapezoid. Further, when trapezoid beam profiles may be assumed, the determination of edge and center signals may be replaced by equivalent evaluations making use of properties of the trapezoid beam profile such as determination of the slope and position of the edges and of the height of the central plateau and deriving edge and center signals by geometric considerations.

In one embodiment, A1 may correspond to a full or complete area of a feature point on the optical sensor. A2 may be a central area of the feature point on the optical sensor. The central area may be a constant value. The central area may be smaller compared to the full area of the feature point. For example, in case of a circular feature point, the central area may have a radius from 0.1 to 0.9 of a full radius of the feature point, preferably from 0.4 to 0.6 of the full radius.

In one embodiment, the illumination pattern may comprise at least one line pattern. A1 may correspond to an area with a full line width of the line pattern on the optical sensors, in particular on the light sensitive area of the optical sensors. The line pattern on the optical sensor may be widened and/or displaced compared to the line pattern of the illumination pattern such that the line width on the optical sensors is increased. In particular, in case of a matrix of optical sensors, the line width of the line pattern on the optical sensors may change from one column to another column. A2 may be a central area of the line pattern on the optical sensor. The line width of the central area may be a constant value, and may in particular correspond to the line width in the illumination pattern. The central area may have a smaller line width compared to the full line width. For example, the central area may have a line width from 0.1 to 0.9 of the full line width, preferably from 0.4 to 0.6 of the full line width. The line pattern may be segmented on the optical sensors. Each column of the matrix of optical sensors may comprise center information of intensity in the central area of the line pattern and edge information of intensity from regions extending further outwards from the central area to edge regions of the line pattern.

In one embodiment, the illumination pattern may comprise at least point pattern. A1 may correspond to an area with a full radius of a point of the point pattern on the optical sensors. A2 may be a central area of the point in the point pattern on the optical sensors. The central area may be a constant value. The central area may have a radius compared to the full radius. For example, the central area may have a radius from 0.1 to 0.9 of the full radius, preferably from 0.4 to 0.6 of the full radius.

The illumination pattern may comprise both at least one point pattern and at least one line pattern. Other embodiments in addition or alternatively to line pattern and point pattern are feasible.

The evaluation device may be configured to derive the quotient Q by one or more of dividing the first area and the second area, dividing multiples of the first area and the second area, dividing linear combinations of the first area and the second area. The evaluation device may be configured for deriving the quotient Q by

$$Q = \frac{\int {\int }_{A 1} E ( x , y ) dxdy}{\int {\int }_{A 2} E ( x , y ) dxdy}$$

wherein x and y are transversal coordinates, A1 and A2 are the first and second area of the beam profile, respectively, and E(x,y) denotes the beam profile.

Additionally or alternatively, the evaluation device may be adapted to determine one or both of center information or edge information from at least one slice or cut of the light spot. This may be realized, for example, by replacing the area integrals in the quotient Q by a line integral along the slice or cut. For improved accuracy, several slices or cuts through the light spot may be used and averaged. In case of an elliptical spot profile, averaging over several slices or cuts may result in improved distance information.

For example, in case of the optical sensor having a matrix of pixels, the evaluation device may be configured for evaluating the beam profile, by
determining the pixel having the highest sensor signal and forming at least one center signal;
evaluating sensor signals of the matrix and forming at least one sum signal;
determining the quotient Q by combining the center signal and the sum signal; and
determining at least one longitudinal coordinate z of the object by evaluating the quotient Q.

As used herein, a “sensor signal” generally refers to a signal generated by the optical sensor and/or at least one pixel of the optical sensor in response to illumination. Specifically, the sensor signal may be or may comprise at least one electrical signal, such as at least one analogue electrical signal and/or at least one digital electrical signal. More specifically, the sensor signal may be or may comprise at least one voltage signal and/or at least one current signal. More specifically, the sensor signal may comprise at least one photocurrent. Further, either raw sensor signals may be used, or the detector, the optical sensor or any other element may be adapted to process or preprocess the sensor signal, thereby generating secondary sensor signals, which may also be used as sensor signals, such as preprocessing by filtering or the like. The term “center signal” generally refers to the at least one sensor signal comprising essentially center information of the beam profile. As used herein, the term “highest sensor signal” refers to one or both of a local maximum or a maximum in a region of interest. For example, the center signal may be the signal of the pixel having the highest sensor signal out of the plurality of sensor signals generated by the pixels of the entire matrix or of a region of interest within the matrix, wherein the region of interest may be predetermined or determinable within an image generated by the pixels of the matrix. The center signal may arise from a single pixel or from a group of optical sensors, wherein, in the latter case, as an example, the sensor signals of the group of pixels may be added up, integrated or averaged, in order to determine the center signal. The group of pixels from which the center signal arises may be a group of neighboring pixels, such as pixels having less than a predetermined distance from the actual pixel having the highest sensor signal, or may be a group of pixels generating sensor signals being within a predetermined range from the highest sensor signal. The group of pixels from which the center signal arises may be chosen as large as possible in order to allow maximum dynamic range. The evaluation device may be adapted to determine the center signal by integration of the plurality of sensor signals, for example the plurality of pixels around the pixel having the highest sensor signal. For example, the beam profile may be a trapezoid beam profile and the evaluation device may be adapted to determine an integral of the trapezoid, in particular of a plateau of the trapezoid.

As outlined above, the center signal generally may be a single sensor signal, such as a sensor signal from the pixel in the center of the light spot, or may be a combination of a plurality of sensor signals, such as a combination of sensor signals arising from pixels in the center of the light spot, or a secondary sensor signal derived by processing a sensor signal derived by one or more of the aforementioned possibilities. The determination of the center signal may be performed electronically, since a comparison of sensor signals is fairly simply implemented by conventional electronics, or may be performed fully or partially by software. Specifically, the center signal may be selected from the group consisting of: the highest sensor signal; an average of a group of sensor signals being within a predetermined range of tolerance from the highest sensor signal; an average of sensor signals from a group of pixels containing the pixel having the highest sensor signal and a predetermined group of neighboring pixels; a sum of sensor signals from a group of pixels containing the pixel having the highest sensor signal and a predetermined group of neighboring pixels; a sum of a group of sensor signals being within a predetermined range of tolerance from the highest sensor signal; an average of a group of sensor signals being above a predetermined threshold; a sum of a group of sensor signals being above a predetermined threshold; an integral of sensor signals from a group of optical sensors containing the optical sensor having the highest sensor signal and a predetermined group of neighboring pixels; an integral of a group of sensor signals being within a predetermined range of tolerance from the highest sensor signal; an integral of a group of sensor signals being above a predetermined threshold.

Similarly, the term “sum signal” generally refers to a signal comprising essentially edge information of the beam profile. For example, the sum signal may be derived by adding up the sensor signals, integrating over the sensor signals or averaging over the sensor signals of the entire matrix or of a region of interest within the matrix, wherein the region of interest may be predetermined or determinable within an image generated by the optical sensors of the matrix. When adding up, integrating over or averaging over the sensor signals, the actual optical sensors from which the sensor signal is generated may be left out of the adding, integration or averaging or, alternatively, may be included into the adding, integration or averaging. The evaluation device may be adapted to determine the sum signal by integrating signals of the entire matrix, or of the region of interest within the matrix. For example, the beam profile may be a trapezoid beam profile and the evaluation device may be adapted to determine an integral of the entire trapezoid. Further, when trapezoid beam profiles may be assumed, the determination of edge and center signals may be replaced by equivalent evaluations making use of properties of the trapezoid beam profile such as determination of the slope and position of the edges and of the height of the central plateau and deriving edge and center signals by geometric considerations.

Similarly, the center signal and edge signal may also be determined by using segments of the beam profile such as circular segments of the beam profile. For example, the beam profile may be divided into two segments by a secant or a chord that does not pass the center of the beam profile. Thus, one segment will essentially contain edge information, while the other segment will contain essentially center information. For example, to further reduce the amount of edge information in the center signal, the edge signal may further be subtracted from the center signal.

The quotient Q may be a signal which is generated by combining the center signal and the sum signal. Specifically, the determining may include one or more of: forming a quotient of the center signal and the sum signal or vice versa; forming a quotient of a multiple of the center signal and a multiple of the sum signal or vice versa; forming a quotient of a linear combination of the center signal and a linear combination of the sum signal or vice versa. Additionally or alternatively, the quotient Q may comprise an arbitrary signal or signal combination which contains at least one item of information on a comparison between the center signal and the sum signal.

As used herein, the term “longitudinal coordinate of the object” refers to a distance between the optical sensor and the object. The evaluation device may be configured for using the at least one predetermined relationship between the quotient Q and the longitudinal coordinate for determining the longitudinal coordinate. The predetermined relationship may be one or more of an empiric relationship, a semi-empiric relationship and an analytically derived relationship. The evaluation device may comprise at least one data storage device for storing the predetermined relationship, such as a lookup list or a lookup table.

The evaluation device may be configured for determining at least one three-dimensional image and/or 3D-data using the determined beam profile information. The image or images recorded by the camera comprising the reflection pattern may be a two-dimensional image or two-dimensional images. As outlined above, the evaluation device may be configured for determining for each of the reflection features a longitudinal coordinate. The evaluation device may be configured for generating 3D-data and/or the three-dimensional image by merging the two-dimensional image or images of the reflection pattern with the determined longitudinal coordinate of the respective reflection feature.

The evaluation device may be configured for merging and/or fusing the determined 3D-data and/or the three-dimensional image and the information determined from the first image, i.e. the at least one geometrical feature and its location, in order to identify the object in a scene, in particular in the area.

The evaluation device is configured for identifying the reflection features which are located inside an image region the geometrical feature and/or for identifying the reflection features which are located outside the image region of the geometrical feature. The evaluation device may be configured for determining an image position of the identified geometrical feature in the first image. The image position may be defined by pixel coordinates, e.g. x and y coordinates, of pixels of the geometrical feature. The evaluation device may be configured for determining and/or assigning and/or selecting at least one border and/or limit of the geometrical feature in the first image. The border and/or limit may be given by at least one edge or at least one contours of the geometrical feature. The evaluation device may be configured for determining the pixels of the first image inside the border and/or limit and their image position in the first image. The evaluation device may be configured for determining at least one image region of the second image corresponding to the geometrical feature in the first image by identifying the pixels of the second image corresponding to the pixels of the first image inside the border and/or limit of the geometrical feature. As used herein, the term “image region” may refer to an area of an image, e.g. given by an amount of pixels and/or pixel coordinates. As used herein, the term “located inside” an image region refers to pixels of the image region and/or belonging to the image region. As used herein, the term “located outside” the image region may refer to pixels at a different location or region of the image as the pixels inside the image region.

The evaluation device is configured for determining the at least one depth level from the beam profile information of the reflection features located inside and/or outside of the image region of the geometrical feature. The area comprising the object may comprise a plurality of elements at different depth levels. As used herein, the term “depth level” may refer to a bin or step of a depth map of the pixels of the second image. As outlined above, the evaluation device may be configured for determining for each of the reflection features a longitudinal coordinate from their beam profiles. The evaluation device may be configured for determining the depth levels from the longitudinal coordinates of the reflection features located inside and/or outside of the image region of the geometrical feature. Metallic objects often cannot be identified in the second image correctly. However, levels can be correctly identified, which may be defined by the ground or cover of said metallic objects since these often are made of cardboard. The evaluation device may be configured for determining the depth level on which the object is located from the depth level of the reflection features located inside and/or outside of the image region of the geometrical feature.

The evaluation device is configured for determining the position and/or the orientation of the object by considering the depth level and pre-determined or predefined information about shape and/or size of the object. For example, the information about shape and/or size may be entered by a user via the user interface of the detector. For example, the information about shape and size may be measured in an additional measurement. As outlined above, the evaluation device is configured for determining the depth level on which the object is located. If in addition, the shape and/or size of the object are known the evaluation device can determine the position and orientation of the object.

For example, in case a task may be to detect and measure with the detector at least one object such as bottles in a box. The detector, in particular the optical sensor, may be installed on a robot arm such that the detector can move to different positions with respect to the objects in the box. The task may be that the robot should move to the objects and take it out of the box. Additionally, the user knows the object, in this example the bottles, in detail, such that the size, form and shape may be also known and may be programmed into the evaluation device.

The optical sensor may determine the two dimensional image and a resulting 3d depth map. The depth map may estimate the position of the detector and the objects. The depth map can also be distorted by different effects like to shiny objects, e.g. metal, and/or the 3d depth map may be to sparse. The present invention propose to get additional information by a 2d image that corresponds to the 3d depth map. In the example with the bottles, the task is to detect bottles in a box. In addition, it may be known that the bottles are rotationally symmetric. Certain features of the botte can helps for object detection, e.g. round bottle caps. This may lead to search for circles or ellipsoids in the 2d image for the object detection with image processing algorithms. A rough estimation of the size of the ellipsoids may be computed by the 3d depth information. For a detailed object detection, the detected ellipsoids in the 2d image and the known relation of the projection between detector and the real world can be used to determine the size and position of the circles in the real word. A relationship between the projection between detector and the real world can be used to determine size, position and orientation by using at least one system of equations.

The evaluation device is configured for determining the at least one material property of the object from the beam profile information of the reflection features located inside and/or outside of the image region of the geometrical feature. With respect to details of determining the material property reference is made to European patent application 19 163 250.4 filed on Mar. 15, 2019, the full content of which is included by reference.

The beam profile information may comprise information about a material property of the surface point or region having reflected the illumination feature. The object may comprise at least one surface on which the illumination pattern is projected. The surface may be adapted to at least partially reflect the illumination pattern back towards the detector.

As used herein, the term “material property” refers to at least one arbitrary property of the material configured for characterizing and/or identification and/or classification of the material.

For example, the material property may be a property selected from the group consisting of: roughness, penetration depth of light into the material, a property characterizing the material as biological or non-biological material, a reflectivity, a specular reflectivity, a diffuse reflectivity, a surface property, a measure for translucence, a scattering, specifically a back-scattering behavior or the like. The at least one material property may be a property selected from the group consisting of: a scattering coefficient, a translucency, a transparency, a deviation from a Lambertian surface reflection, a speckle, and the like.

The evaluation device may be configured for determining the material property of the surface point having reflected the illumination feature. As used herein, the term “determining the material property” refers to assigning the material property to the object. The detector may comprise at least one database comprising a list and/or table, such as a lookup list or a lookup table, of predefined and/or predetermined material properties. The list and/or table of material properties may be determined and/or generated by performing at least one test measurement using the detector according to the present invention, for example by performing material tests using samples having known material properties. The list and/or table of material properties may be determined and/or generated at the manufacturer site and/or by the user of the detector. The material property may additionally be assigned to a material classifier such as one or more of a material name, a material group such as biological or non-biological material, translucent or non-translucent materials, metal or non-metal, skin or non-skin, fur or non-fur, carpet or non-carpet, reflective or non-reflective, specular reflective or non-specular reflective, foam or non-foam, hair or non-hair, roughness groups or the like. The database may comprise a list and/or table comprising the material properties and associated material name and/or material group.

Specifically, the detector may be configured for detection of biological tissue, in particular human skin. As used herein, the term “biological tissue” generally refers to biological material comprising living cells. The detector may be a device for detection, in particular optical detection, of biological tissue, in particular of human skin. The term “detection of biological tissue” refers to determining and/or validating whether a surface to be examined or under test is or comprises biological tissue, in particular human skin, and/or to distinguish biological tissue, in particular human skin, from other tissues, in particular other surfaces, and/or distinguishing different types of biological tissue such as distinguishing different types of human tissue e.g. muscle, fat, organs, or the like. For example, the biological tissue may be or may comprise human tissue or parts thereof such as skin, hair, muscle, fat, organs, or the like. For example, the biological tissue may be or may comprise animal tissue or a part thereof such as skin, fur, muscle, fat, organs, or the like. For example, the biological tissue may be or may comprise plant tissue or a part thereof. The detector may be adapted to distinguish animal tissue or parts thereof from one or more of inorganic tissue, metal surfaces, plastics surfaces, for example of farming machines or milking machines. The detector may be adapted to distinguish plant tissue or parts thereof from one or more of inorganic tissue, metal surfaces, plastics surfaces, for example of farming machines. The detector may be adapted to distinguish food and/or beverage from dish and/or glasses. The detector may be adapted to distinguish different types of food such as a fruit, meat, and fish. The detector may be adapted to distinguish a cosmetics product and/or, an applied cosmetics product from human skin. The detector may be adapted to distinguish human skin from foam, paper, wood, a display, a screen. The detector may be adapted to distinguish human skin from cloth. The detector may be adapted to distinguish a maintenance product from material of machine components such metal components etc. The detector may be adapted to distinguish organic material from inorganic material. The detector may be adapted to distinguish human biological tissue from surfaces of artificial or non-Hying objects. The detector may be used, in particular, for non-therapeutic and non-diagnostic applications.

For example, the material property may be information whether the object is or comprises biological tissue. Without wishing to be bound by this theory, human skin may have a reflection beam profile, also denoted back scattering profile, comprising parts generated by back reflection of the surface, denoted as surface reflection, and parts generated by very diffuse reflection from light penetrating the skin, denoted as diffuse part of the back reflection. With respect to reflection profile of human skin reference is made to “Lasertechnik in der Medizin: Grundlagen, Systeme, Anwendungen”, “Wirkung von Laserstrahlung auf Gewebe”, 1991, pages 171 to 266, Jürgen Eichler, Theo Seiler, Springer Verlag, ISBN 0939-0979. The surface reflection of the skin may increase with the wavelength increasing towards the near infrared. Further, the penetration depth may increase with increasing wavelength from visible to near infrared. The diffuse part of the back reflection may increase with penetrating depth of the light. These properties may be used to distinguish skin from other materials, by analyzing the back scattering beam profile. The surface may be determined as biological tissue in case the reflection beam profile fulfills at least one predetermined or predefined criterion. The at least one predetermined or predefined criterion may be at least one property and/or value suitable to distinguish biological tissue, in particular human skin, from other materials. Specifically, the evaluation device may be adapted for comparing the beam profile with at least one predetermined and/or prerecorded and/or predefined beam profile. The predetermined and/or prerecorded and/or predefined beam profile may be stored in a table or a lookup table and may be determined e.g. empirically, and may, as an example, be stored in at least one data storage device of the detector. For example, the predetermined and/or prerecorded and/or predefined beam profile may be determined during initial start-up of a mobile device comprising the detector. For example, the predetermined and/or prerecorded and/or predefined beam profile may be stored in at least one data storage device of the mobile device, e.g. by software, specifically by the app downloaded from an app store or the like. The surface may be indicated as biological tissue in case the beam profile and the predetermined and/or prerecorded and/or predefined beam profile are identical. The comparison may comprise overlaying the reflection beam profile and the predetermined or predefined beam profile such that their centers of intensity match. The comparison may comprise determining a deviation, e.g. a sum of squared point to point distances, between the beam profile and the predetermined and/or prerecorded and/or predefined beam profile.

The evaluation device may be adapted to compare the determined deviation with at least one threshold, wherein in case the determined deviation is below and/or equal the threshold the surface is indicated as biological tissue and/or the detection of biological tissue is confirmed. The threshold value may be stored in a table or a lookup table and may be determined e.g. empirically and may, as an example, be stored in at least one data storage device of the detector.

Additionally or alternatively, the evaluation device may be configured for comparing the quotient Q with at least one predetermined or predefined quotient threshold value, wherein in case the quotient Q is below and/or equal the quotient threshold the surface is indicated as biological tissue. The quotient threshold value may be stored in a table or a lookup table and may be determined e.g. empirically and may, as an example, be stored in at least one data storage device of the detector. For example, in case A1 and A2 were chosen to comprise essentially edge and essentially center information, respectively, the surface reflection may contribute mostly to the center signal, whereas the diffuse reflection from skin penetration may contribute mostly to the edge integral.

As a further criterion for distinguishing, for example, human skin and non-skin objects, peak intensity of the beam profile may be used in combination with a distance between the detector and the object. The peak intensity of the beam profile may be distance dependent. For example, the peak intensity of the beam profile multiplied by the square of the distance between object and detector may be used as a criterion. In case of using this criterion, the output light intensity of the illumination source may be monitored and the criterion may be corrected for deviations, such as by using a corrected peak intensity of the beam profile which is the peak intensity of the reflection beam profile divided by the output light intensity of the illumination source. The distance between the object and the detector may be obtained by using depth-from-photon-ratio, as outlined above.

Additionally or alternatively, the evaluation device may be configured for determining the material property m by evaluation of the respective beam profiles of the reflection features. As further used herein, the term “evaluating the beam profile” may refer to applying at least one material dependent image filter to the beam profile and/or to at least one specific region of the beam profile. The evaluation device may be configured for determining at least one material feature ϕ₂ₘ by applying at least one material dependent image filter ϕ₂ to the reflection feature. As further used herein, the term “image” refers to a two-dimensional function, f(x,y), wherein brightness and/or color values are given for any x,y-position in the image. The position may be discretized corresponding to the recording pixels. The brightness and/or color may be discretized corresponding to a bit-depth of the optical sensors. As used herein, the term “image filter” refers to at least one mathematical operation applied to the beam profile and/or to the at least one specific region of the beam profile. Specifically, the image filter ϕ maps an image f, or a region of interest in the image, onto a real number, ϕ(f(x,y))=φ, wherein φ denotes a feature, in particular a distance feature in case of distance dependent image filters and a material feature in case of material dependent image filters. Images may be subject to noise and the same holds true for features. Therefore, features may be random variables. The features may be normally distributed. If features are not normally distributed, they may be transformed to be normally distributed such as by a Box-Cox-Transformation.

The evaluation device may be configured for determining the material property m by evaluating the material feature ϕ₂ₘ. As used herein, the term “material dependent” image filter refers to an image having a material dependent output. The output of the material dependent image filter is denoted herein “material feature φ₂ₘ” or “material dependent feature φ₂ₘ”. The material feature may be or may comprise at least one information about the at least one material property of the object.

The material dependent image filter may be at least one filter selected from the group consisting of: a luminance filter; a spot shape filter; a squared norm gradient; a standard deviation; a smoothness filter such as a Gaussian filter or median filter; a grey-level-occurrence-based contrast filter; a grey-level-occurrence-based energy filter; a grey-level-occurrence-based homogeneity filter; a grey-level-occurrence-based dissimilarity filter; a Law's energy filter; a threshold area filter; or a linear combination thereof; or a further material dependent image filter ϕ₂ₒₜₕₑᵣ which correlates to one or more of the luminance filter, the spot shape filter, the squared norm gradient, the standard deviation, the smoothness filter, the grey-level-occurrence-based energy filter, the grey-level-occurrence-based homogeneity filter, the grey-level-occurrence-based dissimilarity filter, the Law's energy filter, or the threshold area filter, or a linear combination thereof by |ρ_{ϕ2other, ϕm}|≥0.40 with ϕₘ being one of the luminance filter, the spot shape filter, the squared norm gradient, the standard deviation, the smoothness filter, the grey-level-occurrence-based energy filter, the grey-level-occurrence-based homogeneity filter, the grey-level-occurrence-based dissimilarity filter, the Law's energy filter, or the threshold area filter, or a linear combination thereof. The further material dependent image filter ϕ₂ₒₜₕₑᵣ may correlate to one or more of the material dependent image filters ϕₘ by |ρ_{ϕ2other, ϕm}|≥0.60, preferably by |ρ_{ϕ2other, ϕm}|≥10.80.

The material dependent image filter may be at least one arbitrary filter ϕ that passes a hypothesis testing. As used herein, the term “passes a hypothesis testing” refers to the fact that a Null-hypothesis H₀ is rejected and an alternative hypothesis H₁ is accepted. The hypothesis testing may comprise testing the material dependency of the image filter by applying the image filter to a predefined data set. The data set may comprise a plurality of beam profile images. As used herein, the term “beam profile image” refers to a sum of N_{B} Gaussian radial basis functions,

fₖ(x, y)=|Σₗ₌₀^{N}^{_{B}}⁻¹gₗₖ(x, y)|,

gₗₖ(x, y)=aₗₖe^{-(a(x-x}^{ₗₖ}⁾⁾^{²} e^{-(a(y-y}^{ₗₖ}⁾⁾^{²}

wherein each of the N_{B} Gaussian radial basis functions is defined by a center (xₗₖ,yₗₖ), a prefactor, aₗₖ, and an exponential factor α=1/∈. The exponential factor is identical for all Gaussian functions in all images. The center-positions, xₗₖ, yₗₖ, are identical for all images fₖ: (x₀,x₁, . . . ,x_{N}_{_{B-1}}), (y₀,y₁, . . . ,y_{N}_{_{B-1}}). Each of the beam profile images in the dataset may correspond to a material classifier and a distance. The material classifier may be a label such as ‘Material A’, ‘Material B’, etc. The beam profile images may be generated by using the above formula for fₖ(x,y) in combination with the following parameter table:

| Image | Material classifier, | Dis- | |
|---|---|---|---|
| Index | Material Index | tance z | Parameters |
| k = 0 | Skin, m = 0 | 0.4 m | (α₀₀, α₁₀, . . ., α_{N}_{_{B}}_{-1 0}) |
| k = 1 | Skin, m = 0 | 0.6 m | (α₀₁, α₁₁, . . ., α_{N}_{_{B}}_{-1 1}) |
| k = 2 | Fabric, m = 1 | 0.6 m | (α₀₂, α₁₂, . . ., α_{N}_{_{B}}_{-1 2)} |
| . . . | | . . . | |
| k = N | Material J, m = J − 1 | | (α_{0N}, α_{1N}, . . ., α_{N}_{_{B}}_{-1 N}) |

The values for x, y, are integers corresponding to pixels with

$$( \begin{matrix}x \\ y\end{matrix} ) ∈ {[ 0 , 1 , … 31 ]}^{2} .$$

The images may have a pixel size of 32×32. The dataset of beam profile images may be generated by using the above formula for fₖ in combination with a parameter set to obtain a continuous description of fₖ. The values for each pixel in the 32×32-image may be obtained by inserting integer values from 0, . . . , 31 for x, y, in fₖ(x,y). For example, for pixel (6,9), the value fₖ(6,9) may be computed.

Subsequently, for each image fₖ, the feature value φₖ corresponding to the filter ϕ may be calculated, Φ(fₖ(x, y), zₖ)=φₖ, wherein zₖ is a distance value corresponding to the image fₖ from the predefined data set. This yields a dataset with corresponding generated feature values φₖ. The hypothesis testing may use a Null-hypothesis that the filter does not distinguish between material classifier. The Null-Hypothesis may be given by H₀: μ₁=μ₂= . . . =μ_{J}, wherein μₘ is the expectation value of each material-group corresponding to the feature values φₖ. Index m denotes the material group. The hypothesis testing may use as alternative hypothesis that the filter does distinguish between at least two material classifiers. The alternative hypothesis may be given by H₁: ∃m, [symbol] : μₘ≠μₘ′. As used herein, the term “not distinguish between material classifiers” refers to that the expectation values of the material classifiers are identical. As used herein, the term “distinguishes material classifiers” refers to that at least two expectation values of the material classifiers differ. As used herein “distinguishes at least two material classifiers” is used synonymous to “suitable material classifier”. The hypothesis testing may comprise at least one analysis of variance (ANOVA) on the generated feature values. In particular, the hypothesis testing may comprise determining a mean-value of the feature values for each of the J materials, i.e. in total J mean values,

$${\overline{φ}}_{m} = \frac{{Σ}_{i} {φ}_{i , m}}{{N}_{m}} ,$$

for m ∈[0,1, . . . , J−1], wherein Nₘ gives the number of feature values for each of the J materials in the predefined data set. The hypothesis testing may comprise determining a mean-value of all N feature values

$$\overline{φ} = \frac{{Σ}_{m} {Σ}_{i} {φ}_{i , m}}{N} .$$

The hypothesis testing may comprise determining a Mean Sum Squares within:

mssw=(ΣₘΣᵢ(φ_{i,m}−φ̅ₘ)²)/(N−J).

The hypothesis testing may comprise determining a Mean Sum of Squares between,

mssb=(Σₘ(φ̅ₘ−φ̅)^{2N}ₘ)/(J−1).

The hypothesis testing may comprise performing an F-Test:

$$CDF ( x ) = {I}_{\frac{{d}_{1} x}{{d}_{1} x + {d}_{2}}} ( \frac{{d}_{1}}{2} , \frac{{d}_{2}}{2} ) , where {d}_{1} = N - J , {d}_{2} = J - 1 , \\ F ( x ) = 1 - CDF ( x ) \\ p = F ( mssb / mssw )$$

Herein, Iₓ is the regularized incomplete Beta-Function,

$${I}_{x} ( a , b ) = \frac{B ( x ; a , b )}{B ( a , b )} ,$$

with the Euler Beta-Function B(a,b)=∫₀¹t^{a-1}(1-t)^{b-1}dt and B(x; a, b)=∫₀^{x}t^{a-1}(1-t)^{b-1}dt being the incomplete Beta-Function. The image filter may pass the hypothesis testing if a p-value, p, is smaller or equal than a pre-defined level of significance. The filter may pass the hypothesis testing if p≤0.075, preferably p≤0.05, more preferably p≤0.025, and most preferably p≤0.01. For example, in case the pre-defined level of significance is α=0.075, the image filter may pass the hypothesis testing if the p-value is smaller than α=0.075. In this case the Null-hypothesis H₀ can be rejected and the alternative hypothesis H₁ can be accepted. The image filter thus distinguishes at least two material classifiers. Thus, the image filter passes the hypothesis testing.

In the following, image filters are described assuming that the reflection feature comprises a spot image. A spot image f may be given by a function f: [symbol] ²→ [symbol] _{≥0}, wherein the background of the image f may be already subtracted. However, other reflection features may be possible.

For example, the material dependent image filter may be a luminance filter. The luminance filter may return a luminance measure of a spot as material feature. The material feature may be determined by

$${φ}_{2 m} = Φ ( f , z ) = - \int f ( x ) dx \frac{{z}^{2}}{{d}_{ray} \cdot n} ,$$

where f is the spot image. The distance of the spot is denoted by z, where z may be obtained for example by using a depth-from-defocus or depth-from—photon ratio technique and/or by using a triangulation technique. The surface normal of the material is given by n ∈ [symbol] ³ and can be obtained as the normal of the surface spanned by at least three measured points. The vector d_{ray} ∈ [symbol] ³ is the direction vector of the light source. Since the position of the spot is known by using depth-from—photon ratio technique, wherein the position of the light source is known as a parameter of the detector system, d_{ray}, is the difference vector between spot and light source positions.

For example, the material dependent image filter may be a filter having an output dependent on a spot shape. This material dependent image filter may return a value which correlates to the translucence of a material as material feature. The translucence of materials influences the shape of the spots. The material feature may be given by

$${φ}_{2 m} = Φ ( f ) = \frac{\int H ( f ( x ) - α h ) dx}{\int H ( f ( x ) - β h ) dx} ,$$

wherein 0<α, β<1 are weights for the spot height h, and H denotes the Heavyside function, i.e. H(x)=1: x≥0, H(x)=0: x<0. The spot height h may be determined by

h=∫_{B}_{ᵣ}f(x)dx,

where Bᵣ is an inner circle of a spot with radius r.

For example, the material dependent image filter may be a squared norm gradient. This material dependent image filter may return a value which correlates to a measure of soft and hard transitions and/or roughness of a spot as material feature. The material feature may be defined by

φ₂ₘ=Φ(f)=∫∥∇f(x)∥²dx.

For example, the material dependent image filter may be a standard deviation. The standard deviation of the spot may be determined by

φ₂ₘ=Φ(f)=∫(f(x)−μ)²dx,

Wherein μ is the mean value given by μ=∫(f(x))dx.

For example, the material dependent image filter may be a smoothness filter such as a Gaussian filter or median filter. In one embodiment of the smoothness filter, this image filter may refer to the observation that volume scattering exhibits less speckle contrast compared to diffuse scattering materials. This image filter may quantify the smoothness of the spot corresponding to speckle contrast as material feature. The material feature may be determined by

$${φ}_{2 m} = Φ ( f , z ) = \frac{\int \vert ℱ ( f ) ( x ) - f ( x ) \vert dx}{\int f ( x ) dx} \cdot \frac{1}{z} ,$$

wherein [symbol] is a smoothness function, for example a median filter or Gaussian filter. This image filter may comprise dividing by the distance z, as described in the formula above. The distance z may be determined for example using a depth-from-defocus or depth-from—photon ratio technique and/or by using a triangulation technique. This may allow the filter to be insensitive to distance. In one embodiment of the smoothness filter, the smoothness filter may be based on the standard deviation of an extracted speckle noise pattern. A speckle noise pattern N can be described in an empirical way by

f(x)=f₀(x)·(N(X)+1),

where f₀ is an image of a despeckled spot. N(X) is the noise term that models the speckle pattern. The computation of a despeckled image may be difficult. Thus, the despeckled image may be approximated with a smoothed version of f, i.e. f₀≈ [symbol] (f), wherein [symbol] is a smoothness operator like a Gaussian filter or median filter. Thus, an approximation of the speckle pattern may be given by

$$N ( X ) = \frac{f ( x )}{ℱ ( f ( x ) )} - 1.$$

The material feature of this filter may be determined by

$${φ}_{2 m} = Φ ( f ) = \sqrt{Var ( \frac{f}{ℱ ( f )} - 1 )} ,$$

Wherein Var denotes the variance function.

For example, the image filter may be a grey-level-occurrence-based contrast filter. This material filter may be based on the grey level occurrence matrix M_{f,ρ}(g₁g₂)=[p_{g1,g2}], whereas p_{g1,g2} is the occurrence rate of the grey combination (g₁,g₂)=[f(x₁,y₁),f(x₂,y₂)], and the relation ρ defines the distance between (x₁,y₁) and (x₂,y₂), which is ρ (x,y)=(x+a,y+b) with a and b selected from 0,1.

The material feature of the grey-level-occurrence-based contrast filter may be given by

$${φ}_{2 m} = Φ ( f ) = {\sum }_{i , j = 0}^{N - 1} {{p}_{ij} ( i - j )}^{2} .$$

For example, the image filter may be a grey-level-occurrence-based energy filter. This material filter is based on the grey level occurrence matrix defined above.

The material feature of the grey-level-occurrence-based energy filter may be given by

$${φ}_{2 m} = Φ ( f ) = {\sum }_{i , j = 0}^{N - 1} {( {p}_{ij} )}^{2} .$$

For example, the image filter may be a grey-level-occurrence-based homogeneity filter. This material filter is based on the grey level occurrence matrix defined above. The material feature of the grey-level-occurrence-based homogeneity filter may be given by

$${φ}_{2 m} = Φ ( f ) = {\sum }_{i , j = 0}^{N - 1} \frac{{p}_{ij}}{1 + \vert i - j \vert} .$$

For example, the image filter may be a grey-level-occurrence-based dissimilarity filter. This material filter is based on the grey level occurrence matrix defined above.

The material feature of the grey-level-occurrence-based dissimilarity filter may be given by

$${φ}_{2 m} = Φ ( f ) = - {\sum }_{i , j = 0}^{N - 1} \sqrt{{p}_{ij} log ( {p}_{ij} )} .$$

For example, the image filter may be a Law's energy filter. This material filter may be based on the laws vector L₅=[1,4,6,4,1] and E₅=[−1, −2,0,−2, −1] and the matrices L₅(E₅)^{T} and E₅(L₅)^{T}. The image fₖ is convoluted with these matrices:

$${f}_{k , L 5 E 5}^{*} ( x , y ) = {\sum }_{i - 2}^{2} {\sum }_{j - 2}^{2} {f}_{k} ( x + i , y + j ) {{L}_{5} ( {E}_{5} )}^{T} and \\ {f}_{k , E 5 L 5}^{*} ( x , y ) = {\sum }_{i - 2}^{2} {\sum }_{j - 2}^{2} {f}_{k} ( x + i , y + j ) {{E}_{5} ( {L}_{5} )}^{T} . \\ E = \int \frac{{f}_{k , L 5 E 5}^{*} ( x , y )}{max ( {f}_{k , L 5 E 5}^{*} ( x , y ) )} dxdy , \\ F = \int \frac{{f}_{k , E 5 L 5}^{*} ( x , y )}{max ( {f}_{k , E 5 L 5}^{*} ( x , y ) )} dxdy ,$$

Whereas the material feature of Law's energy filter may be determined by

φ₂ₘ=Φ(f)=E/F.

For example, the material dependent image filter may be a threshold area filter. This material feature may relate two areas in the image plane. A first area Ω1, may be an area wherein the function f is larger than α times the maximum of f. A second area Ω2, may be an area wherein the function f is smaller than α times the maximum of f, but larger than a threshold value ε times the maximum of f. Preferably a may be 0.5 and ε may be 0.05. Due to speckles or noise, the areas may not simply correspond to an inner and an outer circle around the spot center. As an example, Ω1 may comprise speckles or unconnected areas in the outer circle. The material feature may be determined by

$${φ}_{2 m} = Φ ( f ) = \frac{{f}_{Ω 1} 1}{{f}_{Ω 2} 1} ,$$

wherein Ω1={x|f(x)>α·max(f(x))} and Ω2={x|ε·max(f(x))<f(x)<α·max(f(x))}.

The material property m may be determined by using a predetermined relationship between ϕ₂ₘ and m and/or the longitudinal coordinate z of the reflection feature. The evaluation device may be configured for determining the material property m by evaluating the feature ϕ₂ₘ. The evaluation device may be configured for using at least one predetermined relationship between the material feature ϕ₂ₘ and the material property of the object for determining the material property of the object. The predetermined relationship may be one or more of an empirical relationship, a semi-empiric relationship and an analytically derived relationship. The evaluation device may comprise at least one data storage device for storing the predetermined relationship, such as a lookup list or a lookup table. For example, the material property may be determined by evaluating ϕ₂ₘ subsequently after determining of the longitudinal coordinate z such that the information about the longitudinal coordinate z can be considered for evaluating of ϕ₂ₘ. Specifically, the material property m by a function m(z, ϕ₂ₘ). The function may be predefined and/or predetermined. For example, the function may be a linear function.

As outlined above, the detector may be configured for classify the material of the elements of the area comprising the object. In contrast to structured light the detector according to the present invention may be configured for evaluating each of the reflection features of the second image such that for each reflection feature it may be possible to determine information about its material property.

The evaluation device is configured for determining at least one position and/or orientation of the object by considering the material property and the pre-determined or predefined information about shape and/or size of the object. Generally, identification of the object may be possible using only of the 2d image information or the 3D depth map. However, quality can be enhanced by fusion of 2d and 3d information. Reflecting surfaces are generally problematic for optical 3D measurements. In case of reflecting surfaces using 2d image information only may be possible. In case of objects, which are highly reflective, 3d measurements may relate to erroneous depth map. For identification of such object the 2d information may be essential.

The detector may fully or partially be integrated into at least one housing.

The detector may further comprise one or more additional elements such as one or more additional optical elements. The detector may comprise at least one optical element selected from the group consisting of: transfer device, such as at least one lens and/or at least one lens system, at least one diffractive optical element. The term “transfer device”, also denoted as “transfer system”, may generally refer to one or more optical elements which are adapted to modify the light beam, such as by modifying one or more of a beam parameter of the light beam, a width of the light beam or a direction of the light beam. The transfer device may be adapted to guide the light beam onto the optical sensors. The transfer device specifically may comprise one or more of: at least one lens, for example at least one lens selected from the group consisting of at least one focus-tunable lens, at least one aspheric lens, at least one spheric lens, at least one Fresnel lens; at least one diffractive optical element; at least one concave mirror; at least one beam deflection element, preferably at least one mirror; at least one beam splitting element, preferably at least one of a beam splitting cube or a beam splitting mirror; at least one multi-lens system. As used herein, the term “focal length” of the transfer device refers to a distance over which incident collimated rays which may impinge the transfer device are brought into a “focus” which may also be denoted as “focal point”. Thus, the focal length constitutes a measure of an ability of the transfer device to converge an impinging light beam. Thus, the transfer device may comprise one or more imaging elements which can have the effect of a converging lens. By way of example, the transfer device can have one or more lenses, in particular one or more refractive lenses, and/or one or more convex mirrors. In this example, the focal length may be defined as a distance from the center of the thin refractive lens to the principal focal points of the thin lens. For a converging thin refractive lens, such as a convex or biconvex thin lens, the focal length may be considered as being positive and may provide the distance at which a beam of collimated light impinging the thin lens as the transfer device may be focused into a single spot. Additionally, the transfer device can comprise at least one wavelength-selective element, for example at least one optical filter. Additionally, the transfer device can be designed to impress a predefined beam profile on the electromagnetic radiation, for example, at the location of the sensor region and in particular the sensor area. The abovementioned optional embodiments of the transfer device can, in principle, be realized individually or in any desired combination.

The transfer device may have an optical axis. In particular, the detector and the transfer device have a common optical axis. As used herein, the term “optical axis of the transfer device” generally refers to an axis of mirror symmetry or rotational symmetry of the lens or lens system. The optical axis of the detector may be a line of symmetry of the optical setup of the detector. The detector comprises at least one transfer device, preferably at least one transfer system having at least one lens. The transfer system, as an example, may comprise at least one beam path, with the elements of the transfer system in the beam path being located in a rotationally symmetrical fashion with respect to the optical axis. Still, as will also be outlined in further detail below, one or more optical elements located within the beam path may also be off-centered or tilted with respect to the optical axis. In this case, however, the optical axis may be defined sequentially, such as by interconnecting the centers of the optical elements in the beam path, e.g. by interconnecting the centers of the lenses, wherein, in this context, the optical sensors are not counted as optical elements. The optical axis generally may denote the beam path. Therein, the detector may have a single beam path along which a light beam may travel from the object to the optical sensors, or may have a plurality of beam paths. As an example, a single beam path may be given or the beam path may be split into two or more partial beam paths. In the latter case, each partial beam path may have its own optical axis. The optical sensors may be located in one and the same beam path or partial beam path. Alternatively, however, the optical sensors may also be located in different partial beam paths.

The transfer device may constitute a coordinate system, wherein a longitudinal coordinate is a coordinate along the optical axis and wherein d is a spatial offset from the optical axis. The coordinate system may be a polar coordinate system in which the optical axis of the transfer device forms a z-axis and in which a distance from the z-axis and a polar angle may be used as additional coordinates. A direction parallel or antiparallel to the z-axis may be considered a longitudinal direction, and a coordinate along the z-axis may be considered a longitudinal coordinate. Any direction perpendicular to the z-axis may be considered a transversal direction, and the polar coordinate and/or the polar angle may be considered a transversal coordinate.

With regard to the coordinate system for determining the position of the object, which may be a coordinate system of the detector, the detector may constitute a coordinate system in which an optical axis of the detector forms the z-axis and in which, additionally, an x-axis and a y-axis may be provided which are perpendicular to the z-axis and which are perpendicular to each other. As an example, the detector and/or a part of the detector may rest at a specific point in this coordinate system, such as at the origin of this coordinate system. In this coordinate system, a direction parallel or antiparallel to the z-axis may be regarded as a longitudinal direction, and a coordinate along the z-axis may be considered a longitudinal coordinate. An arbitrary direction perpendicular to the longitudinal direction may be considered a transversal direction, and an x- and/or y-coordinate may be considered a transversal coordinate.

Alternatively, other types of coordinate systems may be used. Thus, as an example, a polar coordinate system may be used in which the optical axis forms a z-axis and in which a distance from the z-axis and a polar angle may be used as additional coordinates. Again, a direction parallel or antiparallel to the z-axis may be considered a longitudinal direction, and a coordinate along the z-axis may be considered a longitudinal coordinate. Any direction perpendicular to the z-axis may be considered a transversal direction, and the polar coordinate and/or the polar angle may be considered a transversal coordinate.

As outlined above, the detector may be enabled to determine the at least one longitudinal coordinate of the object, including the option of determining the longitudinal coordinate of the whole object or of one or more parts thereof. For example, the detector may be configured for determining the longitudinal coordinate of the object by using the depth-from-photon-ratio technique as outlined above. In addition, however, other coordinates of the object, including one or more transversal coordinates and/or rotational coordinates, may be determined by the detector, specifically by the evaluation device. Thus, as an example, one or more transversal sensors may be used for determining at least one transversal coordinate of the object. At least one of the optical sensors may determined from which a center signal arises. This may provide information on the at least one transversal coordinate of the object, wherein, as an example, a simple lens equation may be used for optical transformation and for deriving the transversal coordinate. Additionally or alternatively, one or more additional transversal sensors may be used and may be comprised by the detector. Various transversal sensors are generally known in the art, such as the transversal sensors disclosed in WO 2014/097181 A1 and/or other position-sensitive devices (PSDs), such as quadrant diodes, CCD or CMOS chips or the like. Additionally or alternatively, as an example, the detector according to the present invention may comprise one or more PSDs disclosed in R. A. Street (Ed.): Technology and Applications of Amorphous Silicon, Springer-Verlag Heidelberg, 2010, pp. 346-349. Other embodiments are feasible. These devices may generally also be implemented into the detector according to the present invention. As an example, a part of the light beam may be split off within the detector, by at least one beam splitting element. The split-off portion, as an example, may be guided towards a transversal sensor, such as a CCD or CMOS chip or a camera sensor, and a transversal position of a light spot generated by the split-off portion on the transversal sensor may be determined, thereby determining at least one transversal coordinate of the object. Consequently, the detector according to the present invention may either be a one-dimensional detector, such as a simple distance measurement device, or may be embodied as a two-dimensional detector or even as a three-dimensional detector. Further, as outlined above or as outlined in further detail below, by scanning a scenery or an environment in a one-dimensional fashion, a three-dimensional image may also be created. Consequently, the detector according to the present invention specifically may be one of a one-dimensional detector, a two-dimensional detector or a three-dimensional detector. The evaluation device may further be configured for determining at least one transversal coordinate x, y of the object. The evaluation device may be adapted to combine the information of the longitudinal coordinate and the transversal coordinate and to determine a position of the object in space.

The use of a matrix of optical sensors provides a plurality of advantages and benefits. Thus, a center of the light spot generated by the light beam on the sensor element, such as on the common plane of the light-sensitive areas of the optical sensors of the matrix of the sensor element, may vary with a transversal position of the object. The use of the matrix of optical sensors, thus, provides a significant flexibility in terms of the position of the object, specifically in terms of a transversal position of the object. The transversal position of the light spot on the matrix of optical sensors, such as the transversal position of the at least one optical sensor generating the sensor signal, may be used as an additional item of information, from which at least one item of information on a transversal position of the object may be derived, as e.g. disclosed in WO 2014/198629 A1. Additionally or alternatively, the detector according to the present invention may contain at least one additional transversal detector for, in addition to the at least one longitudinal coordinate, detecting at least one transversal coordinate of the object.

In a further aspect, the present invention discloses a method for object recognition, wherein a detector according to the present invention is used. The method comprises the following steps:
a) projecting at least one illumination pattern comprising a plurality of illumination features on at least one area of comprising at least one object;
b) determining at least one first image comprising at least one two dimensional image of the area using an optical sensor, wherein the optical sensor has at least one light sensitive area;
c) determining at least one second image comprising a plurality of reflection features comprising a plurality of reflection features generated by the area in response to illumination by the illumination features by using the optical sensor;
d) evaluating the first image by using at least one evaluation device, wherein the evaluating of the first image comprises identifying at least one pre-defined or pre-determined geometrical feature;
e) evaluating the second image by using the evaluation device, wherein each of the reflections features comprises at least one beam profile, wherein the evaluation of the second image comprises determining beam profile information for each of the reflection features by analysis of their beam profiles and determining at least one three-dimensional image using the determined beam profile information;
f) identifying the reflection features which are located inside the geometrical feature and/or for identifying the reflection features which are located outside of the geometrical feature by using the evaluation device;
g) determining at least one depth level from the beam profile information of the reflection features located inside and/or outside of the geometrical feature by using the evaluation device;
h) determining at least one material property of the object from the beam profile information of the re-flection features located inside and/or outside of the image region of the geometrical feature by using the evaluation device;
i) determining at least one position and/or orientation of the object by considering the depth level and/or the material property and pre-determined or predefined information about shape and/or size of the object by using the evaluation device.

The method steps may be performed in the given order or may be performed in a different order. Further, one or more additional method steps may be present which are not listed. Further, one, more than one or even all of the method steps may be performed repeatedly. For details, options and definitions, reference may be made to the detector as discussed above. Thus, specifically, as outlined above, the method may comprise using the detector according to the present invention, such as according to one or more of the embodiments given above or given in further detail below.

The at least one evaluation device may be configured for performing at least one computer program, such as at least one computer program configured for performing or supporting one or more or even all of the method steps of the method according to the present invention. As an example, one or more algorithms may be implemented which may determine the position of the object.

In a further aspect of the present invention, use of the detector according to the present invention, such as according to one or more of the embodiments given above or given in further detail below, is proposed, for a purpose of use, selected from the group consisting of: a position measurement in traffic technology; an entertainment application; a security application; a surveillance application; a safety application; a human-machine interface application; a tracking application; a photography application; an imaging application or camera application; a mapping application for generating maps of at least one space; a homing or tracking beacon detector for vehicles; an outdoor application; a mobile application; a communication application; a machine vision application; a robotics application; a quality control application; a manufacturing application.

With respect to further uses of the detector and devices of the present invention reference is made to WO 2018/091649 A1, WO 2018/091638 A1 and WO 2018/091640 A1, the content of which is included by reference.

Specifically, the present invention may be applied in the field of machine control such as for robotic application. For example, the present invention may be applied for controlling at least one gripper of a robot arm. As outlined above, the detector may be configured for determining position of objects, in particular metallic objects, which can be used for control of a gripper or vacuum gripper.

Overall, in the context of the present invention, the following embodiments are regarded as preferred:

Embodiment 1: Detector for object recognition comprising

at least one illumination source configured for projecting at least one illumination pattern comprising a plurality of illumination features on at least one area comprising at least one object;

an optical sensor having at least one light sensitive area, wherein the optical sensor is configured for determining at least one first image comprising at least one two dimensional image of the area, wherein the optical sensor is configured for determining at least one second image comprising a plurality of reflection features generated by the area in response to illumination by the illumination features;

at least one evaluation device, wherein the evaluation device is configured for evaluating the first image and the second image, wherein each of the reflections features comprises at least one beam profile, wherein the evaluation device is configured for determining beam profile information for each of the reflection features by analysis of their beam profiles, wherein the evaluation device is configured for determining at least one three-dimensional image using the determined beam profile information, wherein the evaluation of the first image comprises identifying at least one pre-defined or pre-determined geometrical feature, wherein the evaluation device is configured for identifying the reflection features which are located inside an image region the geometrical feature and/or for identifying the reflection features which are located outside the image region of the geometrical feature,

wherein the evaluation device is configured for determining at least one depth level from the beam profile information of the reflection features located inside and/or outside of the image region of the geometrical feature,

wherein the evaluation device is configured for determining at least one material property of the object from the beam profile information of the reflection features located inside and/or outside of the image region of the geometrical feature,

wherein the evaluation device is configured for determining at least one position and/or orientation of the object by considering the depth level and/or the material property and pre-determined or predefined information about shape and/or size of the object.

Embodiment 2: The detector according to the preceding embodiment, wherein the first image and the second image are determined at different time points.

Embodiment 3: The detector according to any one of the preceding embodiments, wherein the geometrical feature is at least one characteristic element of the object selected from the group consisting of: a shape, a relative position of at least one edge, at least one borehole, at least one reflection point, at least one line, at least one surface, at least one circle, at least one disk, the full object, a part of the object and the like.

Embodiment 4: The detector according to any one of the preceding embodiments, wherein the evaluation device comprises at least one data storage device, wherein the data storage device comprises at least one table and/or at least one lookup table of geometrical features and/or pre-determined or predefined information about shape and/or size of the object.

Embodiment 5: The detector according to any one of the preceding embodiments, wherein the evaluation device is configured for identifying the geometrical feature by using at least one image processing process, wherein the image processing process comprises one or more of at least one template matching algorithm; at least one Hough-transformation; applying a Canny edge filter; applying a Sobel filter; applying a combination of filters.

Embodiment 6: The detector according to any one of the preceding embodiments, wherein the evaluation device is configured for performing at least one plausibility check, wherein the identified geometrical feature are compared to at least one known geometrical features of the object.

Embodiment 7: The detector according to any one of the preceding embodiments, wherein the illumination source is configured for generating the at least one illumination pattern in the infrared region.

Embodiment 8: The detector according to any one of the preceding embodiments, wherein the detector comprises at least one first filter element, wherein the first filter element is configured for transmitting light in the infrared spectral range and for at least partially blocking light of other spectral ranges.

Embodiment 9: The detector according to the preceding embodiment, wherein the first filter element is a monochromatic bandpass filter configured for transmitting light in a small spectral range, wherein the spectral range is ±100 nm, preferably ±50 nm, most preferably ±35 nm.

Embodiment 10: The detector according to any one of the preceding embodiments, wherein the detector comprises at least one second filter element, wherein the second filter element is configured for transmitting light in the visual spectral range and for at least partially blocking light of other spectral ranges.

Embodiment 11: The detector according to any one of the preceding embodiments, wherein the illumination pattern comprises at least one periodic point pattern having a low point density, wherein the illumination pattern has ≤2500 points per field of view.

Embodiment 12: The detector according to any one of the preceding embodiments, wherein the detector comprises at least one control unit, wherein the control unit is configured for controlling the optical sensor and/or the illumination source.

Embodiment 13: The detector according to the preceding embodiment, wherein the control unit is configured for triggering projecting of the illumination pattern and/or imaging of the second image.

Embodiment 14: The detector according to any one of the two preceding embodiments, wherein the control unit is configured for adapting exposure time for projection of the illumination pattern.

Embodiment 15: The detector according to any one of the two preceding embodiments, wherein the detector comprises at least one further illumination source configured for illuminating the area for determining the first image, wherein control unit is configured for controlling the further illumination source, wherein the control unit is configured for triggering illumination of the area by light generated by the further illumination source and imaging of the first image.

Embodiment 16: The detector according to the preceding embodiment, wherein the further illumination source comprises one or more of at least one light source such as at least one light emitting diode (LED) or at least one VCSEL array, wherein the further illumination source comprises at least one optical element such as at least one diffusor or at least one lens.

Embodiment 17: The detector according to any one of the two preceding embodiments, wherein the control unit is configured for adapting exposure time for projection of the illumination pattern and illumination by light generated by the further illumination source.

Embodiment 18: The detector according to any one of the preceding embodiments, wherein the evaluation device is configured for determining the beam profile information for each of the reflection features by using depth-from-photon-ratio technique.

Embodiment 19: The detector according to any one of the preceding embodiments, wherein the optical sensor comprises at least one CMOS sensor.

Embodiment 20: Method for object recognition, wherein at least one detector according to the preceding embodiments is used, wherein the method comprises the following steps:
a) projecting at least one illumination pattern comprising a plurality of illumination features on at least one area of comprising at least one object;
b) determining at least one first image comprising at least one two dimensional image of the area using an optical sensor, wherein the optical sensor has at least one light sensitive area;
c) determining at least one second image comprising a plurality of reflection features comprising a plurality of reflection features generated by the area in response to illumination by the illumination features by using the optical sensor;
d) evaluating the first image by using at least one evaluation device, wherein the evaluating of the first image comprises identifying at least one pre-defined or pre-determined geometrical feature;
e) evaluating the second image by using the evaluation device, wherein each of the reflections features comprises at least one beam profile, wherein the evaluation of the second image comprises determining beam profile information for each of the reflection features by analysis of their beam profiles and determining at least one three-dimensional image using the determined beam profile information;
f) identifying the reflection features which are located inside the geometrical feature and/or for identifying the reflection features which are located outside of the geometrical feature by using the evaluation device;
g) determining at least one depth level from the beam profile information of the reflection features located inside and/or outside of the geometrical feature by using the evaluation device;
h) determining at least one material property of the object from the beam profile information of the re-flection features located inside and/or outside of the image region of the geometrical feature by using the evaluation device;
i) determining at least one position and/or orientation of the object by considering the depth level and/or the material property and pre-determined or predefined information about shape and/or size of the object by using the evaluation device.

Embodiment 21: A use of the detector according to any one of the preceding embodiments relating to a detector, for a purpose of use, selected from the group consisting of: a position measurement in traffic technology; an entertainment application; a security application; a surveillance application; a safety application; a human-machine interface application; a tracking application; a photography application; an imaging application or camera application; a mapping application for generating maps of at least one space; a homing or tracking beacon detector for vehicles; an outdoor application; a mobile application; a communication application; a machine vision application; a robotics application; a quality control application; a manufacturing application.

### BRIEF DESCRIPTION OF THE FIGURES

Further optional details and features of the invention are evident from the description of preferred exemplary embodiments which follows in conjunction with the dependent claims. In this context, the particular features may be implemented in an isolated fashion or in combination with other features. The invention is not restricted to the exemplary embodiments. The exemplary embodiments are shown schematically in the figures. Identical reference numerals in the individual figures refer to identical elements or elements with identical function, or elements which correspond to one another with regard to their functions.

Specifically, in the figures:

FIG. 1 shows an embodiment of a detector according to the present invention.

### DETAILED DESCRIPTION OF THE EMBODIMENTS

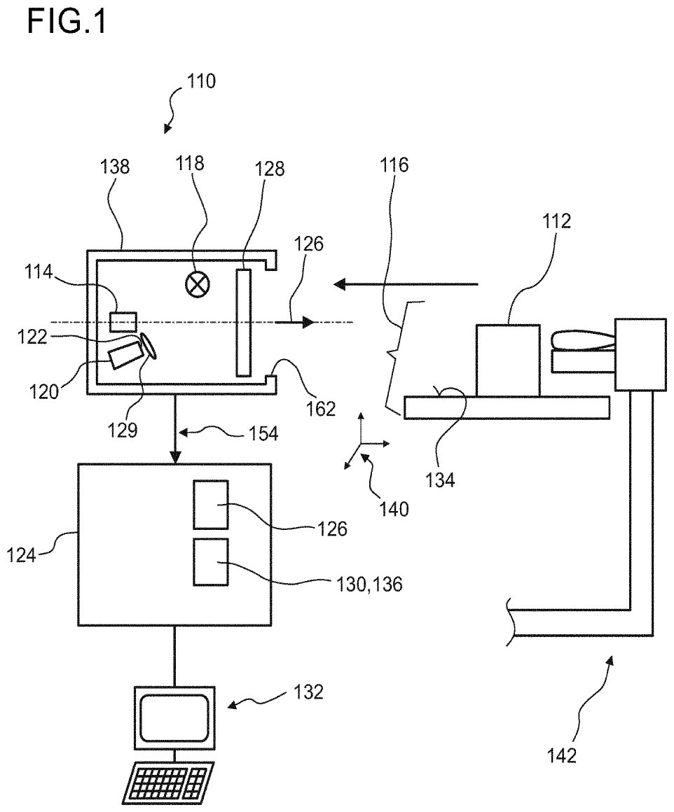

FIG. 1 shows in a highly schematic fashion an embodiment of a detector for object recognition. The object 112 may generally refer to an arbitrary physical body whose orientation and/or position is to be determined. The object 112 may be at least one article. For example, the object may be at least one object selected from the group consisting of: a box, a bottle, a plate, a sheet of paper, a bag, a screw, a washer, a machined metal piece, a rubber seal, plastic pieces, wrapping, packing material.

The detector 110 comprises at least one illumination source 114 configured for projecting at least one illumination pattern comprising a plurality of illumination features on at least one area 116 comprising at least one object 112. The object 112 may be located within a scene and/or may have a surrounding environment. Specifically, the object 112 may be located in the at least one area 116. The area 116 may be at least one surface and/or region. The area 116 may comprise additional elements such as the surrounding environment.

The illumination source 114 may be adapted to directly or indirectly illuminating the object 112, wherein the illumination pattern is reflected or scattered by the object 112 and, thereby, is at least partially directed towards the detector 110. The illumination source 114 may be adapted to illuminate the object 112, for example, by directing a light beam towards the object 112, which reflects the light beam. The illumination source 114 may be configured for generating an illuminating light beam for illuminating the object 112.

The illumination source 114 may comprise at least one light source. The illumination source 114 may comprise a plurality of light sources. The illumination source may comprise an artificial illumination source, in particular at least one laser source and/or at least one incandescent lamp and/or at least one semiconductor light source, for example, at least one light-emitting diode, in particular an organic and/or inorganic light-emitting diode. As an example, the light emitted by the illumination source 114 may have a wavelength of 300 to 1100nm, especially 500 to 1100 nm. Additionally or alternatively, light in the infrared spectral range may be used, such as in the range of 780 nm to 3.0 μm. Specifically, the light in the part of the near infrared region where silicon photodiodes are applicable specifically in the range of 700 nm to 1100 nm may be used. The illumination source 114 may be configured for generating the at least one illumination pattern in the infrared region. Using light in the near infrared region allows that light is not or only weakly detected by human eyes and is still detectable by silicon sensors, in particular standard silicon sensors.

The illumination source 114 may be or may comprise at least one multiple beam light source. For example, the illumination source 114 may comprise at least one laser source and one or more diffractive optical elements (DOEs). Specifically, the illumination source 114 may comprise at least one laser and/or laser source. Various types of lasers may be employed, such as semiconductor lasers, double heterostructure lasers, external cavity lasers, separate confinement heterostructure lasers, quantum cascade lasers, distributed bragg reflector lasers, polariton lasers, hybrid silicon lasers, extended cavity diode lasers, quantum dot lasers, volume Bragg grating lasers, Indium Arsenide lasers, transistor lasers, diode pumped lasers, distributed feedback lasers, quantum well lasers, interband cascade lasers, Gallium Arsenide lasers, semi-conductor ring laser, extended cavity diode lasers, or vertical cavity surface-emitting lasers. Additionally or alternatively, non-laser light sources may be used, such as LEDs and/or light bulbs. The illumination source 114 may comprise one or more diffractive optical elements (DOEs) adapted to generate the illumination pattern. For example, the illumination source 114 may be adapted to generate and/or to project a cloud of points, for example the illumination source may comprise one or more of at least one digital light processing projector, at least one LCoS projector, at least one spatial light modulator; at least one diffractive optical element; at least one array of light emitting diodes; at least one array of laser light sources. On account of their generally defined beam profiles and other properties of handleability, the use of at least one laser source as the illumination source is particularly preferred. The illumination source 114 may be integrated into a housing of the detector 110.

The illumination pattern may comprise a plurality of illumination features. The illumination pattern may be selected from the group consisting of: at least one point pattern; at least one line pattern; at least one stripe pattern; at least one checkerboard pattern; at least one pattern comprising an arrangement of periodic or non periodic features. The illumination pattern may comprise regular and/or constant and/or periodic pattern such as a triangular pattern, a rectangular pattern, a hexagonal pattern or a pattern comprising further convex tilings. The illumination pattern may exhibit the at least one illumination feature selected from the group consisting of: at least one point; at least one line; at least two lines such as parallel or crossing lines; at least one point and one line; at least one arrangement of periodic or non-periodic feature; at least one arbitrary shaped featured. The illumination pattern may comprise at least one pattern selected from the group consisting of: at least one point pattern, in particular a pseudo-random point pattern; a random point pattern or a quasi random pattern; at least one Sobol pattern; at least one quasiperiodic pattern; at least one pattern comprising at least one preknown feature at least one regular pattern; at least one triangular pattern; at least one hexagonal pattern; at least one rectangular pattern at least one pattern comprising convex uniform tilings; at least one line pattern comprising at least one line; at least one line pattern comprising at least two lines such as parallel or crossing lines. For example, the illumination source 114 may be adapted to generate and/or to project a cloud of points. The illumination source 114 may comprise the at least one light projector adapted to generate a cloud of points such that the illumination pattern may comprise a plurality of point pattern. The illumination source 114 may comprise at least one mask adapted to generate the illumination pattern from at least one light beam generated by the illumination source 114.

Specifically, the illumination source 114 comprises at least one laser source and/or at least one laser diode which is designated for generating laser radiation. The illumination source 114 may comprise the at least one diffractive optical element (DOE). The detector 110 may comprise at least one point projector, such as the at least one laser source and the DOE, adapted to project at least one point pattern.

For example, the projected illumination pattern may be a periodic point pattern. The projected illumination pattern may have a low point density. For example, the illumination pattern may comprise at least one periodic point pattern having a low point density, wherein the illumination pattern has ≤2500 points per field of view. In comparison with structured light having typically a point density of 10 k-30 k in a field of view of 55×38° the illumination pattern according to the present invention may be less dense. This may allow more power per point such that the proposed technique is less dependent on ambient light compared to structured light.

The detector 110 may comprise at least one further illumination source 118. The further illumination source 118 may comprise one or more of at least one further light source such as at least one light emitting diode (LED) or at least one vertical-cavity surface-emitting laser (VCSEL) array. The further illumination source 118 may comprise at least one optical element such as at least one diffusor or at least one lens. The further illumination source 118 may be configured for providing additional illumination for imaging of the first image. For example, the further illumination source 118 may be used in situations in which it is not possible or difficult for recording the reflection pattern, e.g. in case of highly reflective metallic surfaces, in order to ensure a good illumination and, thus, contrasts for two-dimensional images such that a two-dimensional image recognition is possible.

The detector 110 comprises an optical sensor 120 having at least one light sensitive area 122. The optical sensor 120 is configured for determining at least one first image comprising at least one two dimensional image of the area 116. The optical sensor 120 is configured for determining at least one second image comprising a plurality of reflection features generated by the area 116 in response to illumination by the illumination features. The detector 110 may comprise a single camera comprising the optical sensor 120. The detector 110 may comprise a plurality of cameras each comprising an optical sensor 120 or a plurality of optical sensors 120.

The optical sensor 120 specifically may be or may comprise at least one photodetector, preferably inorganic photodetectors, more preferably inorganic semiconductor photodetectors, most preferably silicon photodetectors. Specifically, the optical sensor 120 may be sensitive in the infrared spectral range. All pixels of the matrix or at least a group of the optical sensors of the matrix specifically may be identical. Groups of identical pixels of the matrix specifically may be provided for different spectral ranges, or all pixels may be identical in terms of spectral sensitivity. Further, the pixels may be identical in size and/or with regard to their electronic or optoelectronic properties. Specifically, the optical sensor 120 may be or may comprise at least one inorganic photodiode which are sensitive in the infrared spectral range, preferably in the range of 700 nm to 3.0 micrometers. Specifically, the optical sensor 120 may be sensitive in the part of the near infrared region where silicon photodiodes are applicable specifically in the range of 700 nm to 1100 nm. Infrared optical sensors which may be used for optical sensors may be commercially available infrared optical sensors, such as infrared optical sensors commercially available under the brand name Hertzstueck™ from trinamiX™ GmbH, D-67056 Ludwigshafen am Rhein, Germany. Thus, as an example, the optical sensor 120 may comprise at least one optical sensor of an intrinsic photovoltaic type, more preferably at least one semiconductor photodiode selected from the group consisting of: a Ge photodiode, an InGaAs photodiode, an extended InGaAs photodiode, an InAs photodiode, an InSb photodiode, a HgCdTe photodiode. Additionally or alternatively, the optical sensor 120 may comprise at least one optical sensor of an extrinsic photovoltaic type, more preferably at least one semiconductor photodiode selected from the group consisting of: a Ge:Au photodiode, a Ge:Hg photodiode, a Ge:Cu photodiode, a Ge:Zn photodiode, a Si:Ga photodiode, a Si:As photodiode. Additionally or alternatively, the optical sensor 120 may comprise at least one photoconductive sensor such as a PbS or PbSe sensor, a bolometer, preferably a bolometer selected from the group consisting of a VO bolometer and an amorphous Si bolometer.

The optical sensor 120 may be sensitive in one or more of the ultraviolet, the visible or the infrared spectral range. Specifically, the optical sensor may be sensitive in the visible spectral range from 500 nm to 780 nm, most preferably at 650 nm to 750 nm or at 690 nm to 700 nm. Specifically, the optical sensor may be sensitive in the near infrared region. Specifically, the optical sensor 120 may be sensitive in the part of the near infrared region where silicon photodiodes are applicable specifically in the range of 700 nm to 1000 nm. The optical sensor 120, specifically, may be sensitive in the infrared spectral range, specifically in the range of 780 nm to 3.0 micrometers. For example, the optical sensor each, independently, may be or may comprise at least one element selected from the group consisting of a photodiode, a photocell, a photoconductor, a phototransistor or any combination thereof. For example, the optical sensor 120 may be or may comprise at least one element selected from the group consisting of a CCD sensor element, a CMOS sensor element, a photodiode, a photocell, a photoconductor, a phototransistor or any combination thereof. Any other type of photosensitive element may be used. The photosensitive element generally may fully or partially be made of inorganic materials and/or may fully or partially be made of organic materials. Most commonly, one or more photodiodes may be used, such as commercially available photodiodes, e.g. inorganic semiconductor photodiodes.

The optical sensor 120 may comprise at least one sensor element comprising a matrix of pixels. Thus, as an example, the optical sensor 120 may be part of or constitute a pixelated optical device. For example, the optical sensor 120 may be and/or may comprise at least one CCD and/or CMOS device. As an example, the optical sensor 120 may be part of or constitute at least one CCD and/or CMOS device having a matrix of pixels, each pixel forming a light-sensitive area. The sensor element may be formed as a unitary, single device or as a combination of several devices. The matrix specifically may be or may comprise a rectangular matrix having one or more rows and one or more columns. The rows and columns specifically may be arranged in a rectangular fashion. However, other arrangements are feasible, such as non-rectangular arrangements. As an example, circular arrangements are also feasible, wherein the elements are arranged in concentric circles or ellipses about a center point. For example, the matrix may be a single row of pixels. Other arrangements are feasible.

The pixels of the matrix specifically may be equal in one or more of size, sensitivity and other optical, electrical and mechanical properties. The light-sensitive areas 122 of all optical sensors 120 of the matrix specifically may be located in a common plane, the common plane preferably facing the object 112, such that a light beam propagating from the object to the detector 110 may generate a light spot on the common plane. The light-sensitive area 122 may specifically be located on a surface of the respective optical sensor 120. Other embodiments, however, are feasible. The optical sensor 120 may comprise for example, at least one CCD and/or CMOS device. As an example, the optical sensor 120 may be part of or constitute a pixelated optical device. As an example, the optical sensor 120 may be part of or constitute at least one CCD and/or CMOS device having a matrix of pixels, each pixel forming a light-sensitive area 122.

The optical sensor 120 is configured for determining at least one first image comprising at least one two dimensional image of the area 116. The image itself, thus, may comprise pixels, the pixels of the image correlating to pixels of the matrix of the sensor element. The optical sensor 120 is configured for determining at least one second image comprising a plurality of reflection features generated by the area 116 in response to illumination by the illumination features.

The first image and the second image may be determined, in particular recorded, at different time points. Recording of the first image and the second time limit may be performed with a temporal shift. Specifically, a single camera comprising the optical sensor 120 may record with a temporal shift a two-dimensional image and an image of a projected pattern. Recording the first and the second image at different time points may ensure that an evaluation device 124 can distinguish between the first and the second image and can apply the appropriate evaluation routine. Moreover, it is possible to adapt the illumination situation for the first image if necessary and in particular independent from the illumination for the second image. The detector 110 may comprise at least one control unit 126. The control unit 126 may be designed as hardware component of the detector 110. In particular, the control unit 126 may comprise at least one microcontroller. The control unit 126 may be configured for controlling the optical sensor 120 and/or the illumination source 114. The control unit 126 may be configured for triggering projecting of the illumination pattern and/or imaging of the second image. Specifically, the control unit 126 may be configured for controlling the optical sensor 120, in particular frame rate and/or illumination time, via trigger signals. The control unit 126 may be configured for adapting and/or adjusting the illumination time from frame to frame. This may allow adapting and/or adjusting illumination time for the first image, e.g. in order to have contrasts at the edges, and at the same time adapting and/or adjusting illumination time for the second image to maintain contrast of the reflection features. Additionally, the control unit 126 may, at the same time and independently, control the elements of the illumination source 114 and/or the further illumination source 118.

Specifically, the control unit 126 may be configured for adapting exposure time for projection of the illumination pattern. The second image may be recorded with different illumination times. Dark regions of the area 116 may require more light in comparison to lighter regions, which may result to run into saturation for the lighter regions. Therefore, the detector 110 may be configured for recording a plurality of images of the reflection pattern, wherein the images may be recorded with different illumination times. The detector 110 may be configured for generating and/or composing the second image from said images. The evaluation device 124 may be configured for performing at least one algorithm on said images which were recorded with different illumination times.

The control unit 126 may be configured for controlling the further illumination source 118. The control unit 126 may be configured for triggering illumination of the area by light generated by the further illumination source 118 and imaging of the first image. The control unit 126 may be configured for adapting exposure time for projection of the illumination pattern and illumination by light generated by the further illumination source 118.

The detector 110 may comprise at least one first filter element 128. The first filter element 128 may be configured for transmitting light in the infrared spectral range and for at least partially blocking light of other spectral ranges. The first filter element 128 may be a monochromatic bandpass filter configured for transmitting light in a small spectral range. For example, the spectral range or bandwidth may be ±100 nm, preferably ±50 nm, most preferably ±35 nm or even less. For example, the first filter element 128 may be configured for transmitting light having a central wavelength of 808 nm, 830 nm, 850 nm, 905 nm or 940 nm. For example, the first filter element 128 may be configured for transmitting light having a central wavelength of 850 nm with a bandwidth of 70 nm or less. The first filter element 128 may have a minimal angle dependency such that the spectral range can be small. This may result in a low dependency on ambient light, wherein at the same time an enhanced vignetting effect can be prevented. For example, the detector 110 may comprise the single camera having the optical sensor 120 and, in addition, the first filter element 128. The first filter element 128 may ensure that even in presence of ambient light recording of the reflection pattern is possible and at the same time to maintain laser output power low such that eye safety operation in laser class 1 is ensured.

Additionally or alternatively, the detector 110 may comprise at least one second filter element, not shown here. The second filter element may be a band-pass filter. For example, the first filter element may be a long pass filter configured for blocking visual light and for let pass light above a wavelength of 780 nm. The band pass filter may be positioned between the light-sensitive area 122, for example of a CMOS chip, and transfer device 129.

The spectrum of the illumination source 114 and/or of the further illumination source 118 may be selected depending on the used filter elements. For example, in case of the first filter element 128 having a central wavelength of 850 nm, the illumination source 114 may comprise at least one light source generating a wavelength of 850 nm such as at least one infrared (IR)-LED.

The detector 110 may comprise at least one transfer device 129 comprising one or more of: at least one lens, for example at least one lens selected from the group consisting of at least one focus-tunable lens, at least one aspheric lens, at least one spheric lens, at least one Fresnel lens; at least one diffractive optical element; at least one concave mirror; at least one beam deflection element, preferably at least one mirror; at least one beam splitting element, preferably at least one of a beam splitting cube or a beam splitting mirror; at least one multi-lens system. In particular, the transfer device 129 may comprise at least one collimating lens adapted to focus at least one object point in an image plane.

The evaluation device 124 is configured for evaluating the first image and the second image.

The evaluation of the first image comprises identifying at least one pre-defined or pre-determined geometrical feature. The geometrical feature may be at least one characteristic element of the object 112 selected from the group consisting of: a shape, a relative position of at least one edge, at least one borehole, at least one reflection point, at least one line, at least one surface, at least one circle, at least one disk, the full object, a part of the object and the like. The evaluation device 124 may comprise at least one data storage device 130. The data storage device 130 may comprise at least one table and/or at least one lookup table of geometrical features and/or pre-determined or predefined information about shape and/or size of the object 112. Additionally or alternatively, the detector 110 may comprise at least one user interface 132 via which a user can enter the at least one geometrical feature.

The evaluation device 124 may be configured for evaluating in a first step the second image. The evaluation of the second image may provide, as will be outlined in more detail below, 3D information of the reflection features. The evaluation device 124 may be configured for estimating a location of the geometrical feature in the first image by considering the 3D information of the reflection features. This may reduce effort of search for geometrical feature in the first image significantly.

The evaluation device 124 may be configured for identifying the geometrical feature by using at least one image processing process. The image processing process may comprise one or more of at least one template matching algorithm; at least one Hough-transformation; applying a Canny edge filter; applying a Sobel filter; applying a combination of filters. The evaluation device may be configured for performing at least one plausibility check. The plausibility check may comprise comparing the identified geometrical feature compared to at least one known geometrical feature of the object. For example, a user may enter a known geometrical feature via the user interface for the plausibility check.

The evaluation device 124 is configured for evaluating of the second image. The evaluation of the second image may comprise generating a three-dimensional image.

Each of the reflections features comprises at least one beam profile. The beam profile may be selected from the group consisting of a trapezoid beam profile; a triangle beam profile; a conical beam profile and a linear combination of Gaussian beam profiles. The evaluation device 124 is configured for determining beam profile information for each of the reflection features by analysis of their beam profiles.

The evaluation device 124 may be configured for determining the beam profile of each of the reflection features. The determining the beam profile may comprise identifying at least one reflection feature provided by the optical sensor 120 and/or selecting at least one reflection feature provided by the optical sensor 120 and evaluating at least one intensity distribution of the reflection feature. As an example, a region of the matrix may be used and evaluated for determining the intensity distribution, such as a three-dimensional intensity distribution or a two-dimensional intensity distribution, such as along an axis or line through the matrix. As an example, a center of illumination by the light beam may be determined, such as by determining the at least one pixel having the highest illumination, and a cross-sectional axis may be chosen through the center of illumination. The intensity distribution may an intensity distribution as a function of a coordinate along this cross-sectional axis through the center of illumination. Other evaluation algorithms are feasible.

The evaluation device 124 may be configured for performing at least one image analysis and/or image processing in order to identify the reflection features. The image analysis and/or image processing may use at least one feature detection algorithm. The image analysis and/or image processing may comprise one or more of the following: a filtering; a selection of at least one region of interest; a formation of a difference image between an image created by the sensor signals and at least one offset; an inversion of sensor signals by inverting an image created by the sensor signals; a formation of a difference image between an image created by the sensor signals at different times; a background correction; a decomposition into color channels; a decomposition into hue; saturation; and brightness channels; a frequency decomposition; a singular value decomposition; applying a blob detector; applying a corner detector; applying a Determinant of Hessian filter; applying a principle curvature-based region detector; applying a maximally stable extremal regions detector; applying a generalized Hough-transformation; applying a ridge detector; applying an affine invariant feature detector; applying an affine-adapted interest point operator; applying a Harris affine region detector; applying a Hessian affine region detector; applying a scale-invariant feature transform; applying a scale-space extrema detector; applying a local feature detector; applying speeded up robust features algorithm; applying a gradient location and orientation histogram algorithm; applying a histogram of oriented gradients descriptor; applying a Deriche edge detector; applying a differential edge detector; applying a spatio-temporal interest point detector; applying a Moravec corner detector; applying a Canny edge detector; applying a Laplacian of Gaussian filter; applying a Difference of Gaussian filter; applying a Sobel operator; applying a Laplace operator; applying a Scharr operator; applying a Prewitt operator; applying a Roberts operator; applying a Kirsch operator; applying a high-pass filter; applying a low-pass filter; applying a Fourier transformation; applying a Radon-transformation; applying a Hough-transformation; applying a wave-let-transformation; a thresholding; creating a binary image. The region of interest may be determined manually by a user or may be determined automatically, such as by recognizing an object within the image generated by the optical sensor 120.

For example, the illumination source 114 may be configured for generating and/or projecting a cloud of points such that a plurality of illuminated regions is generated on the optical sensor, for example the CMOS detector. Additionally, disturbances may be present on the optical sensor such as disturbances due to speckles and/or extraneous light and/or multiple reflections. The evaluation device 124 may be adapted to determine at least one region of interest, for example one or more pixels illuminated by the light beam which are used for determination of the longitudinal coordinate of the object 112. For example, the evaluation device 124 may be adapted to perform a filtering method, for example, a blob-analysis and/or an edge filter and/or object recognition method.

The evaluation device 124 may be configured for performing at least one image correction. The image correction may comprise at least one background subtraction. The evaluation device 124 may be adapted to remove influences from background light from the reflection beam profile, for example, by an imaging without further illumination.

The analysis of the beam profile may comprise evaluating of the beam profile. The analysis of the beam profile may comprise at least one mathematical operation and/or at least one comparison and/or at least symmetrizing and/or at least one filtering and/or at least one normalizing. For example, the analysis of the beam profile may comprise at least one of a histogram analysis step, a calculation of a difference measure, application of a neural network, application of a machine learning algorithm. The evaluation device 124 may be configured for symmetrizing and/or for normalizing and/or for filtering the beam profile, in particular to remove noise or asymmetries from recording under larger angles, recording edges or the like. The evaluation device 124 may filter the beam profile by removing high spatial frequencies such as by spatial frequency analysis and/or median filtering or the like. Summarization may be performed by center of intensity of the light spot and averaging all intensities at the same distance to the center. The evaluation device 124 may be configured for normalizing the beam profile to a maximum intensity, in particular to account for intensity differences due to the recorded distance. The evaluation device 124 may be configured for removing influences from background light from the reflection beam profile, for example, by an imaging without illumination.

The reflection feature may cover or may extend over at least one pixel of the image. For example, the reflection feature may cover or may extend over plurality of pixels. The evaluation device 124 may be configured for determining and/or for selecting all pixels connected to and/or belonging to the reflection feature, e.g. a light spot. The evaluation device 124 may be configured for determining the center of intensity by

$${R}_{coi} = \frac{1}{l \cdot \sum j \cdot {r}_{pixel}} ,$$

wherein R_{coi} is a position of center of intensity, rₚᵢₓₑₗ is the pixel position and l=ΣⱼIₜₒₜₐₗ with j being the number of pixels j connected to and/or belonging to the reflection feature and Iₜₒₜₐₗ being the total intensity.

The evaluation device 124 is configured for determining the beam profile information for each of the reflection features by analysis of their beam profiles. The beam profile information may comprise information about the longitudinal coordinate of the surface point or region having reflected the illumination feature. Additionally, the beam profile information may comprise information about a material property of said surface point or region having reflected the illumination feature.

The beam profile information may be the longitudinal coordinate of the surface point or region having reflected the illumination feature. The evaluation device 124 may be configured for determining the beam profile information for each of the reflection features by using depth-from-photon-ratio technique. With respect to depth-from-photon-ratio (DPR) technique reference is made to WO 2018/091649 A1, WO 2018/091638 A1 and WO 2018/091640 A1, the full content of which is included by reference.

The analysis of the beam profile of one of the reflection features may comprise determining at least one first area and at least one second area of the beam profile. The first area of the beam profile may be an area A1 and the second area of the beam profile may be an area A2. The evaluation device 124 may be configured for integrating the first area and the second area. The evaluation device 124 may be configured to derive a combined signal, in particular a quotient Q, by one or more of dividing the integrated first area and the integrated second area, dividing multiples of the integrated first area and the integrated second area, dividing linear combinations of the integrated first area and the integrated second area. The evaluation device 124 may configured for determining at least two areas of the beam profile and/or to segment the beam profile in at least two segments comprising different areas of the beam profile, wherein overlapping of the areas may be possible as long as the areas are not congruent. For example, the evaluation device 124 may be configured for determining a plurality of areas such as two, three, four, five, or up to ten areas. The evaluation device 124 may be configured for segmenting the light spot into at least two areas of the beam profile and/or to segment the beam profile in at least two segments comprising different areas of the beam profile. The evaluation device 124 may be configured for determining for at least two of the areas an integral of the beam profile over the respective area. The evaluation device 124 may be configured for comparing at least two of the determined integrals. Specifically, the evaluation device 124 may be configured for determining at least one first area and at least one second area of the reflection beam profile. The first area of the beam profile and the second area of the reflection beam profile may be one or both of adjacent or overlapping regions. The first area of the beam profile and the second area of the beam profile may be not congruent in area. For example, the evaluation device 124 may be configured for dividing a sensor region of the CMOS sensor into at least two sub-regions, wherein the evaluation device may be configured for dividing the sensor region of the CMOS sensor into at least one left part and at least one right part and/or at least one upper part and at least one lower part and/or at least one inner and at least one outer part. Additionally or alternatively, the detector 110 may comprise at least two optical sensors 120, wherein the light-sensitive areas 122 of a first optical sensor and of a second optical sensor may be arranged such that the first optical sensor is adapted to determine the first area of the reflection beam profile of the reflection feature and that the second optical sensor is adapted to determine the second area of the reflection beam profile of the reflection feature. The evaluation device 124 may be adapted to integrate the first area and the second area. The evaluation device 124 may be configured for using at least one predetermined relationship between the quotient Q and the longitudinal coordinate for determining the longitudinal coordinate. The predetermined relationship may be one or more of an empiric relationship, a semi-empiric relationship and an analytically derived relationship. The evaluation device 124 may comprise at least one data storage device for storing the predetermined relationship, such as a lookup list or a lookup table.

The first area of the beam profile may comprise essentially edge information of the beam profile and the second area of the beam profile comprises essentially center information of the beam profile, and/or the first area of the beam profile may comprise essentially information about a left part of the beam profile and the second area of the beam profile comprises essentially information about a right part of the beam profile. The beam profile may have a center, i.e. a maximum value of the beam profile and/or a center point of a plateau of the beam profile and/or a geometrical center of the light spot, and falling edges extending from the center. The second region may comprise inner regions of the cross section and the first region may comprise outer regions of the cross section. Preferably, the center information has a proportion of edge information of less than 10%, more preferably of less than 5%, most preferably the center information comprises no edge content. The edge information may comprise information of the whole beam profile, in particular from center and edge regions. The edge information may have a proportion of center information of less than 10%, preferably of less than 5%, more preferably the edge information comprises no center content. At least one area of the beam profile may be determined and/or selected as second area of the beam profile if it is close or around the center and comprises essentially center information. At least one area of the beam profile may be determined and/or selected as first area of the beam profile if it comprises at least parts of the falling edges of the cross section. For example, the whole area of the cross section may be determined as first region.

Other selections of the first area A1 and second area A2 may be feasible. For example, the first area may comprise essentially outer regions of the beam profile and the second area may comprise essentially inner regions of the beam profile. For example, in case of a two-dimensional beam profile, the beam profile may be divided in a left part and a right part, wherein the first area may comprise essentially areas of the left part of the beam profile and the second area may comprise essentially areas of the right part of the beam profile.

The evaluation device 124 may be configured to derive the quotient Q by one or more of dividing the first area and the second area, dividing multiples of the first area and the second area, dividing linear combinations of the first area and the second area. The evaluation device 124 may be configured for deriving the quotient Q by

$$Q = \frac{\int {\int }_{A 1} E ( x , y ) dxdy}{\int {\int }_{A 2} E ( x , y ) dxdy}$$

wherein x and y are transversal coordinates, A1 and A2 are the first and second area of the beam profile, respectively, and E(x,y) denotes the beam profile.

The evaluation device 124 may be configured for determining at least one three-dimensional image and/or 3D-data using the determined beam profile information. The image or images recorded by the camera comprising the reflection pattern may be a two-dimensional image or two-dimensional images. As outlined above, the evaluation device 124 may be configured for determining for each of the reflection features a longitudinal coordinate. The evaluation device 124 may be configured for generating 3D-data and/or the three-dimensional image by merging the two-dimensional image or images of the reflection pattern with the determined longitudinal coordinate of the respective reflection feature.

The evaluation device 124 may be configured for merging and/or fusing the determined 3D-data and/or the three-dimensional image and the information determined from the first image, i.e. the at least one geometrical feature and its location, in order to identify the object in a scene, in particular in the area.

The evaluation device 124 is configured for identifying the reflection features which are located inside an image region the geometrical feature and/or for identifying the reflection features which are located outside the image region of the geometrical feature. The evaluation device 124 may be configured for determining an image position of the identified geometrical feature in the first image. The image position may be defined by pixel coordinates, e.g. x and y coordinates, of pixels of the geometrical feature. The evaluation device 124 may be configured for determining and/or assigning and/or selecting at least one border and/or limit of the geometrical feature in the first image. The border and/or limit may be given by at least one edge or at least one contours of the geometrical feature. The evaluation device 124 may be configured for determining the pixels of the first image inside the border and/or limit and their image position in the first image. The evaluation device 124 may be configured for determining at least one image region of the second image corresponding to the geometrical feature in the first image by identifying the pixels of the second image corresponding to the pixels of the first image inside the border and/or limit of the geometrical feature.

The evaluation device 124 is configured for determining the at least one depth level from the beam profile information of the reflection features located inside and/or outside of the image region of the geometrical feature. The area comprising the object may comprise a plurality of elements at different depth levels. The depth level may be a bin or step of a depth map of the pixels of the second image. As outlined above, the evaluation device 124 may be configured for determining for each of the reflection features a longitudinal coordinate from their beam profiles. The evaluation device 124 may be configured for determining the depth levels from the longitudinal coordinates of the reflection features located inside and/or outside of the image region of the geometrical feature. Metallic objects often cannot be identified in the second image correctly. However, levels can be correctly identified, which may be defined by the ground or cover of said metallic objects since these often are made of cardboard. FIG. 1 shows an example, wherein the area 116 comprises a surface 134 on which the object 112 is located. The evaluation device 124 may be configured for determining the depth level on which the object 112 is located from the depth level of the reflection features located inside and/or outside of the image region of the geometrical feature.

The evaluation device 124 is configured for determining the position and/or the orientation of the object by considering the depth level and pre-determined or predefined information about shape and/or size of the object 112. For example, the information about shape and/or size may be entered by a user via the user interface 132. For example, the information about shape and size may be measured in an additional measurement. As outlined above, the evaluation device 124 is configured for determining the depth level on which the object 112 is located. If in addition, the shape and/or size of the object 112 are known the evaluation device 124 can determine the position and orientation of the object.

For example, in case a task may be to detect and measure with the detector 110 at least one object 112 such as bottles in a box. The detector 110, in particular the optical sensor 120, may be installed on a robot arm 142 such that the detector 110 can move to different positions with respect to the objects in the box. The task may be that the robot should move to the objects 112 and take it out of the box. Additionally, the user knows the object 112, in this example the bottles, in detail, such that the size, form and shape may be also known and may be programmed into the evaluation device 124.

The optical sensor 120 may determine the two dimensional image and a resulting 3d depth map. The depth map may estimate the position of the detector 110 and the objects 112. The depth map can also be distorted by different effects like to shiny objects, e.g. metal, and/or the 3d depth map may be to sparse. The present invention propose to get additional information by a 2d image that corresponds to the 3d depth map. In the example with the bottles, the task is to detect bottles in a box. In addition, it may be known that the bottles are rotationally symmetric. Certain features of the botte can helps for object detection, e.g. round bottle caps. This may lead to search for circles or ellipsoids in the 2d image for the object detection with image processing algorithms. A rough estimation of the size of the ellipsoids may be computed by the 3d depth information. For a detailed object detection, the detected ellipsoids in the 2d image and the known relation of the projection between detector 110 and the real world can be used to determine the size and position of the circles in the real word. A relationship between the projection between detector 110 and the real world can be used to determine size, position and orientation by using at least one system of equations.

The evaluation device 124 is configured for determining at least one material property of the object from the beam profile information of the reflection features located inside and/or outside of the image region of the geometrical feature. The beam profile information may comprise information about a material property of the surface point or region having reflected the illumination feature. The object 112 may comprise at least one surface on which the illumination pattern is projected. The surface may be adapted to at least partially reflect the illumination pattern back towards the detector 110. For example, the material property may be a property selected from the group consisting of: roughness, penetration depth of light into the material, a property characterizing the material as biological or non-biological material, a reflectivity, a specular reflectivity, a diffuse reflectivity, a surface property, a measure for translucence, a scattering, specifically a back-scattering behavior or the like. The at least one material property may be a property selected from the group consisting of: a scattering coefficient, a translucency, a transparency, a deviation from a Lambertian surface reflection, a speckle, and the like.

The evaluation device 124 may be configured for determining the material property of the surface point having reflected the illumination feature. The detector 110 may comprise at least one database 136 comprising a list and/or table, such as a lookup list or a lookup table, of predefined and/or predetermined material properties. The list and/or table of material properties may be determined and/or generated by performing at least one test measurement using the detector 110 according to the present invention, for example by performing material tests using samples having known material properties. The list and/or table of material properties may be determined and/or generated at the manufacturer site and/or by the user of the detector 110. The material property may additionally be assigned to a material classifier such as one or more of a material name, a material group such as biological or non-biological material, translucent or non-translucent materials, metal or non-metal, skin or non-skin, fur or non-fur, carpet or non-carpet, reflective or non-reflective, specular reflective or non-specular reflective, foam or non-foam, hair or non-hair, roughness groups or the like. The database 136 may comprise a list and/or table comprising the material properties and associated material name and/or material group.

The evaluation device 124 may be configured for determining the material property m by evaluation of the respective beam profiles of the reflection features. The evaluation device 124 may be configured for determining at least one material feature ϕ₂ₘ by applying at least one material dependent image filter ϕ₂ to the reflection feature. The image may be a two-dimensional function, f(x,y), wherein brightness and/or color values are given for any x,y-position in the image. The position may be discretized corresponding to the recording pixels. The brightness and/or color may be discretized corresponding to a bit-depth of the optical sensors. The image filter may be at least one mathematical operation applied to the beam profile and/or to the at least one specific region of the beam profile. Specifically, the image filter ϕ maps an image f, or a region of interest in the image, onto a real number, ϕ(f(x,y))=φ, wherein φ denotes a feature, in particular a distance feature in case of distance dependent image filters and a material feature in case of material dependent image filters. Images may be subject to noise and the same holds true for features. Therefore, features may be random variables. The features may be normally distributed. If features are not normally distributed, they may be transformed to be normally distributed such as by a Box-Cox-Transformation. The evaluation device 124 may be configured for determining the material property m by evaluating the material feature ϕ₂ₘ. The material feature may be or may comprise at least one information about the at least one material property of the object 112.

The material dependent image filter may be at least one filter selected from the group consisting of: a luminance filter; a spot shape filter; a squared norm gradient; a standard deviation; a smoothness filter such as a Gaussian filter or median filter; a grey-level-occurrence-based contrast filter; a grey-level-occurrence-based energy filter; a grey-level-occurrence-based homogeneity filter; a grey-level-occurrence-based dissimilarity filter; a Law's energy filter; a threshold area filter; or a linear combination thereof; or a further material dependent image filter ϕ₂ₒₜₕₑᵣ which correlates to one or more of the luminance filter, the spot shape filter, the squared norm gradient, the standard deviation, the smoothness filter, the grey-level-occurrence-based energy filter, the grey-level-occurrence-based homogeneity filter, the grey-level-occurrence-based dissimilarity filter, the Law's energy filter, or the threshold area filter, or a linear combination thereof by |ρ_{ϕ2other, ϕm}|≥0.40 with ϕₘ being one of the luminance filter, the spot shape filter, the squared norm gradient, the standard deviation, the smoothness filter, the grey-level-occurrence-based energy filter, the grey-level-occurrence-based homogeneity filter, the grey-level-occurrence-based dissimilarity filter, the Law's energy filter, or the threshold area filter, or a linear combination thereof. The further material dependent image filter ϕ₂ₒₜₕₑᵣ may correlate to one or more of the material dependent image filters ϕₘ by |ρ_{ϕ2other, ϕm}|≥0.60, preferably by |ρ_{ϕ2other, ϕm}|≥0.80.

As outlined above, the detector 110 may be configured for classify the material of the elements of the area 116 comprising the object 112. In contrast to structured light the detector 110 according to the present invention may be configured for evaluating each of the reflection features of the second image such that for each reflection feature it may be possible to determine information about its material property.

The evaluation device 124 is configured for determining at least one position and/or orientation of the object by considering the material property and the pre-determined or predefined information about shape and/or size of the object. Generally, identification of the object 112 may be possible using only of the 2d image information or the 3D depth map. However, quality can be enhanced by fusion of 2d and 3d information. Reflecting surfaces are generally problematic for optical 3D measurements. In case of reflecting surfaces using 2d image information only may be possible. In case of objects, which are highly reflective, 3d measurements may relate to erroneous depth map. For identification of such object the 2d information may be essential.

The detector 110 may fully or partially be integrated into at least one housing 138. As depicted in FIG. 1, the housing 138 includes an opening 162. The opening 162 is preferably located concentrically with regard to an optical axis of the detector 110 and defines a direction of view of the detector 110.

The components of the evaluation device 124 may fully or partially be integrated into a distinct device and/or may fully or partially be integrated into other components of the detector 110. Besides the possibility of fully or partially combining two or more components, the optical sensor 120 and one or more of the components of the evaluation device 124 may be interconnected by one or more connectors 154 and/or by one or more interfaces, as symbolically depicted in FIG. 1. Further, instead of using the at least one optional connector 154, the evaluation device 124 may fully or partially be integrated into the optical sensor 120 and/or into the at least one housing 138 of the detector 110. Additionally or alternatively, the evaluation device 124 may fully or partially be designed as a separate device.

With regard to the coordinate system for determining the position of the object 112, which may be a coordinate system of the detector 110, the detector may constitute a coordinate system 140 in which an optical axis of the detector 110 forms the z-axis and in which, additionally, an x-axis and a y-axis may be provided which are perpendicular to the z-axis and which are perpendicular to each other. As an example, the detector 110 and/or a part of the detector may rest at a specific point in this coordinate system, such as at the origin of this coordinate system. In this coordinate system, a direction parallel or antiparallel to the z-axis may be regarded as a longitudinal direction, and a coordinate along the z-axis may be considered a longitudinal coordinate. An arbitrary direction perpendicular to the longitudinal direction may be considered a transversal direction, and an x- and/or y-coordinate may be considered a transversal coordinate.

The present invention may be applied in the field of machine control such as for robotic application. For example, as shown in FIG. 1, the present invention may be applied for controlling at least one gripper of a robot arm 142. As outlined above, the detector 110 may be configured for determining position of objects, in particular metallic objects, which can be used for control of the robot arm 142. For example, the object 112 may be at least one article. For example, the object 112 may be at least one object selected from the group consisting of: a box, a bottle, a plate, a sheet of paper, a bag, a screw, a washer, a machined metal piece, a rubber seal, plastic pieces, wrapping, packing material

### LIST OF REFERENCE NUMBERS

110 detector

112 object

114 illumination source

116 area

118 further illumination source

120 optical sensor

122 light-sensitive area

124 evaluation device

126 control unit

128 first filter element

129 transfer device

130 data storage device

132 user interface

134 surface

136 database

138 detector system

140 coordinate system

142 robot arm

154 connector

162 opening

### CITED REFERENCES

US 2016/0238377 A1

WO 2018/091649 A1

WO 2018/091638 A1

WO 2018/091640 A1

“Lasertechnik in der Medizin: Grundlagen, Systeme, Anwendungen”, “Wirkung von Laserstrahlung auf Gewebe”, 1991, pages 171 to 266, Jürgen Eichler, Theo Seiler, Springer Verlag, ISBN 0939-097

R. A. Street (Ed.): Technology and Applications of Amorphous Silicon, Springer-Verlag Heidelberg, 2010, pp. 346-349

WO 2014/198629 A1

Chen Guo-Hua et al. “Transparent object detection and location based on RGB-D cam-era”, JOURNAL OF PHYSICS: CONFERENCE SERIES, vol. 1183, 1 Mar. 2019, page 012011, XP055707266, GB ISSN: 1742-6588, DOI: 10.1088/1742-6596/1183/1/012011

1. A detector for object recognition comprising
at least one illumination source configured for projecting at least one illumination pattern comprising a plurality of illumination features on at least one area comprising at least one object;
an optical sensor having at least one light sensitive area, wherein the optical sensor is configured for determining at least one first image comprising at least one two dimensional image of the area, wherein the optical sensor is configured for determining at least one second image comprising a plurality of reflection features generated by the area in response to illumination by the illumination features;
at least one evaluation device, wherein the evaluation device is configured for evaluating the first image and the second image, wherein each of the reflection features comprises at least one beam profile, wherein the evaluation device is configured for determining beam profile information for each of the reflection features by analysis of their beam profiles, wherein the beam profile information is information about an intensity distribution of a light spot on the light sensitive area of the optical sensor, wherein the evaluation device is configured for determining at least one three-dimensional image using the determined beam profile information, wherein the evaluation of the first image comprises identifying at least one pre-defined or pre-determined geometrical feature, wherein the evaluation device is configured for identifying the reflection features which are located inside an image region the geometrical feature and/or for identifying the reflection features which are located outside the image region of the geometrical feature,
wherein the evaluation device is configured for determining at least one depth level from the beam profile information of the reflection features located inside and/or outside of the image region of the geometrical feature,
wherein the evaluation device is configured for determining at least one material property of the object from the beam profile information of the reflection features located inside and/or outside of the image region of the geometrical feature,
wherein the evaluation device is configured for determining at least one position and/or orientation of the object by considering the depth level and/or the material property and pre-determined or predefined information about shape and/or size of the object.

2. The detector according to claim 1, wherein the first image and the second image are determined at different time points.

3. The detector according to claim 1, wherein the geometrical feature is at least one characteristic element of the object selected from the group consisting of: a shape, a relative position of at least one edge, at least one borehole, at least one reflection point, at least one line, at least one surface, at least one circle, at least one disk, the full object, and a part of the object.

4. The detector according to claim 1, wherein the evaluation device comprises at least one data storage device, wherein the data storage device comprises at least one table and/or at least one lookup table of geometrical features and/or pre-determined or predefined information about shape and/or size of the object.

5. The detector according to claim 1, wherein the detector comprises at least one first filter element, wherein the first filter element is configured for transmitting light in the infrared spectral range and for at least partially blocking light of other spectral ranges.

6. The detector according to claim 1, wherein the illumination pattern comprises at least one periodic point pattern having a low point density, wherein the illumination pattern has ≤2500 points per field of view.

7. The detector according to claim 1, wherein the detector comprises at least one control unit, wherein the control unit is configured for controlling the optical sensor and/or the illumination source, wherein the control unit is configured for triggering projecting of the illumination pattern and/or imaging of the second image.

8. The detector according to claim 7, wherein the control unit is configured for adapting exposure time for projection of the illumination pattern.

9. The detector according to claim 1, wherein the evaluation device is configured for determining the beam profile information for each of the reflection features by using depth-from-photon-ratio technique.

10. The detector according to claim 1, wherein the optical sensor comprises at least one CMOS sensor.

11. A method for object recognition, wherein at least one detector according to claim 1 is used, wherein the method comprises the following steps:
a) projecting at least one illumination pattern comprising a plurality of illumination features on at least one area of comprising at least one object;
b) determining at least one first image comprising at least one two dimensional image of the area using an optical sensor, wherein the optical sensor has at least one light sensitive area;
c) determining at least one second image comprising a plurality of reflection features comprising a plurality of reflection features generated by the area in response to illumination by the illumination features by using the optical sensor;
d) evaluating the first image by using at least one evaluation device, wherein the evaluating of the first image comprises identifying at least one pre-defined or pre-determined geometrical feature;
e) evaluating the second image by using the evaluation device, wherein each of the reflection features comprises at least one beam profile, wherein the evaluation of the second image comprises determining beam profile information for each of the reflection features by analysis of their beam profiles and determining at least one three-dimensional image using the determined beam profile information;
f) identifying the reflection features which are located inside the geometrical feature and/or for identifying the reflection features which are located outside of the geometrical feature by using the evaluation device;
g) determining at least one depth level from the beam profile information of the reflection features located inside and/or outside of the geometrical feature by using the evaluation device;
h) determining at least one material property of the object from the beam profile information of the re-flection features located inside and/or outside of the image region of the geometrical feature by using the evaluation device; and
i) determining at least one position and/or orientation of the object by considering the depth level and/or the material property and pre-determined or predefined information about shape and/or size of the object by using the evaluation device.

12. A method of using the detector according to claim 1, for a purpose selected from the group consisting of: a position measurement in traffic technology; an entertainment application; a security application; a surveillance application; a safety application; a human-machine interface application; a tracking application; a photography application; an imaging application or camera application; a mapping application for generating maps of at least one space; a homing or tracking beacon detector for vehicles; an outdoor application; a mobile application; a communication application; a machine vision application; a robotics application; a quality control application; and a manufacturing application.
